(19) United States
(12) Patent Application Publication
(10) Pub. No.: US 2024/0143638 A1
(43) Pub. Date: May 2, 2024

(54) INFORMATION PROCESSING APPARATUS, INFORMATION PROCESSING METHOD, AND INFORMATION PROCESSING COMPUTER PROGRAM PRODUCT

(71) Applicant: KABUSHIKI KAISHA TOSHIBA, Tokyo (JP)

(72) Inventors: Shigeru MAYA, Machida (JP); Yoshinori TSUTABAYASHI, Minato (JP)

(73) Assignee: KABUSHIKI KAISHA TOSHIBA, Tokyo (JP)

(21) Appl. No.: 18/454,119

(22) Filed: Aug. 23, 2023

(30) Foreign Application Priority Data
Oct. 31, 2022 (JP) 2022-174883

(51) Int. Cl. G06F 16/33

(52) U.S. Cl. CPC G06F 16/3347

(57) ABSTRACT

A control unit 20 calculates a search word representation vector and a search document representation vector of a search word on the basis of a first knowledge graph 16B, a second knowledge graph 16C, and first representation vector management information 16D, and searches, on the basis of a combination of the search word representation vector and a plurality of search document representation vectors, a document represented by the search document representation vector included in the combination.

### CROSS-REFERENCE TO RELATED APPLICATIONS

This application is based upon and claims the benefit of priority from Japanese Patent Application No. 2022-174883, filed on Oct. 31, 2022; the entire contents of which are incorporated herein by reference.

### FIELD

Embodiments described herein relate generally to an information processing apparatus, an information processing method, and an information processing computer program product.

### BACKGROUND

There is known a technique of searching for a document corresponding to a search word included in a search formula from a wide variety of documents using a representation vector including multidimensional vectors representing distributed representation of words. For example, a technique of obtaining a representation vector representing a search word and searching for a document having a representation vector similar to the obtained representation vector is disclosed. In addition, a technique for improving the accuracy of the representation vector of the search word using the input history of the user and the thesaurus, and a technique such as document search using the representation vector of the word and a synonym dictionary are disclosed.

However, in conventional technologies, it is necessary to obtain in advance representation vectors of all search words of an enormous amount that may be used for search, but in practice, it is difficult to obtain in advance an enormous amount of representation vectors. Therefore, in the prior art, it is difficult to perform document search using a wide range of search words.

### BRIEF DESCRIPTION OF THE DRAWINGS

FIG. 1 is a diagram of a functional configuration of an information processing apparatus;

FIG. 2 is a schematic diagram of a data configuration of document management information;

FIG. 3A is a schematic diagram of a data configuration of a first knowledge graph;

FIG. 3B is a schematic diagram of a data configuration of the first knowledge graph;

FIG. 4A is a schematic diagram of a data configuration of a second knowledge graph;

FIG. 4B is a schematic diagram of a data configuration of the second knowledge graph;

FIG. 5 is a schematic diagram of a data configuration of first representation vector management information;

FIG. 6 is a flowchart of generation processing of a first knowledge graph;

FIG. 7 is a flowchart of generation processing of a second knowledge graph;

FIG. 8 is a flowchart of representation vector calculation processing;

FIG. 9 is a flowchart of document search processing;

FIG. 10 is a diagram of a functional configuration of an information processing apparatus;

FIG. 11 is a schematic diagram of a data configuration of second representation vector management information;

FIG. 12 is a flowchart of representation vector calculation processing;

FIG. 13 is a flowchart of document search processing;

FIG. 14 is a diagram of a functional configuration of an information processing apparatus;

FIG. 15A is an explanatory diagram of a word with low entropy;

FIG. 15B is an explanatory diagram of a word with high entropy;

FIG. 16 is a flowchart of generation processing of a second knowledge graph;

FIG. 17 is a flowchart of generation processing of a second knowledge graph.

FIG. 18 is a diagram of a functional configuration of an information processing apparatus;

FIG. 19 is a flowchart of document search processing;

FIG. 20 is a diagram of a functional configuration of an information processing apparatus;

FIG. 21 is a schematic diagram of a data configuration of feedback management information;

FIG. 22 is a flowchart of generation processing of a second knowledge graph; and

FIG. 23 is a hardware configuration diagram.

### DETAILED DESCRIPTION

An object of the embodiments herein is to provide an information processing apparatus, an information processing method, and an information processing computer program product capable of performing document search using a wide range of search words.

According to an embodiment, an information processing apparatus includes a hardware processor configured to function as a control unit. The control unit calculates a search word representation vector of a search word and a search document representation vector used for searching a plurality of documents registered in document management information on a basis of first knowledge graph, a second knowledge graph, and first representation vector management information in which a first word representation vector of the first word and a document representation vector of the document including the first word are registered. The first knowledge graph represents a relationship between a document registered in the document management information and a word included in the document. The second knowledge graph represents a relationship between a first word that is the word included in the document and the document including the first word. Additionally, the control unit searches, on a basis of combinations of the search word representation vector and a plurality of the search document representation vectors, the document represented by the search document representation vector included in the combinations. Hereinafter, embodiments of an information processing apparatus, an information processing method, and an information processing computer program product will be described with reference to the drawings.

### First Embodiment

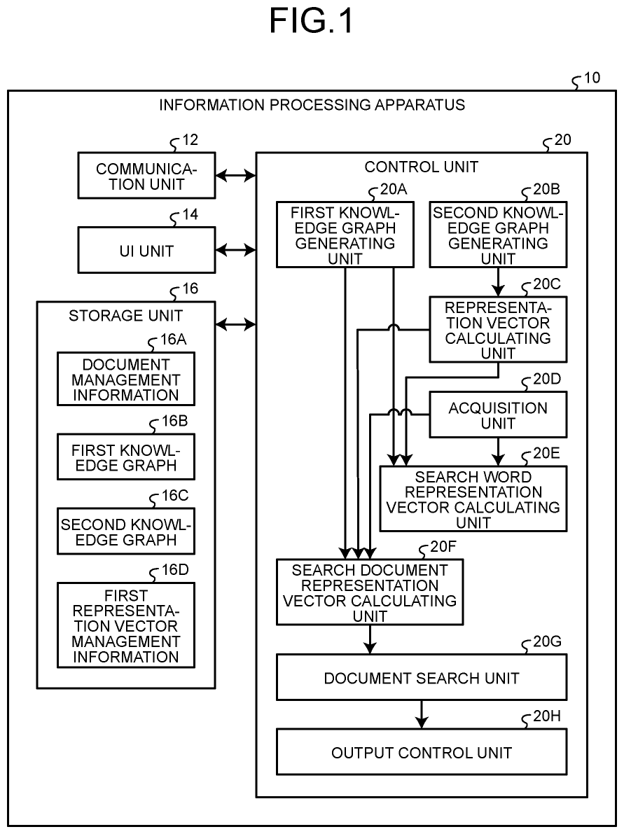

FIG. 1 is a diagram illustrating an example of a functional configuration of an information processing apparatus 10 according to the present embodiment.

The information processing apparatus 10 is an information processing apparatus that provides a search result obtained by searching for a document related to a search word according to a search formula including the search word acquired by an input of a user. The search word is a word serving as a keyword of the search specified by the user.

The information processing apparatus 10 includes a communication unit 12, a user interface (UI) unit 14, a storage unit 16, and a control unit 20. The communication unit 12, the UI unit 14, the storage unit 16, and the control unit 20 are communicably connected by a bus or the like.

The communication unit 12 communicates with an external information processing apparatus via a network or the like. The UI unit 14 has an input function of receiving an operation input by the user and an output function of outputting various types of information. The input function is, for example, an input device such as a keyboard. The output function is a display that displays various types of information, a speaker that outputs sound, or the like.

The storage unit 16 stores various types of information. In the present embodiment, the storage unit 16 stores a document management information 16A, a first knowledge graph 16B, a second knowledge graph 16C, a first representation vector management information 16D, and the like.

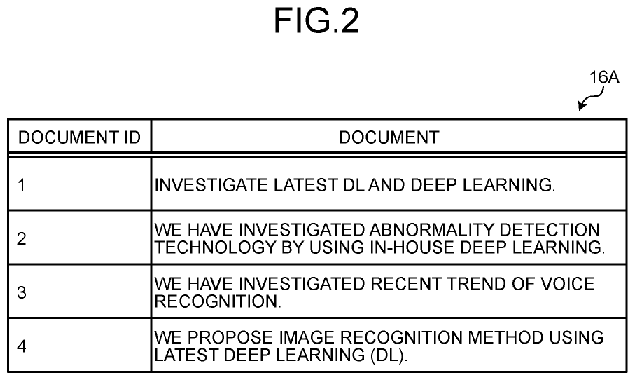

FIG. 2 is a schematic diagram of an example of a data configuration of the document management information 16A.

The document management information 16A is a database for managing documents. For example, the document management information 16A is a database in which a document ID and document data are associated with each other. The data format of the document management information 16A is not limited to the database.

The document is document data that can be acquired by the information processing apparatus 10. All pieces of document data that can be acquired by the information processing apparatus 10 are registered in the document management information 16A. Examples of the document include documents related to announcement materials, intellectual properties, emails, reports, technical books, blogs, social networking services (SNSs), and the like. The language used for the document is not limited, and may be, for example, Japanese, English, or a language other than Japanese and English.

FIG. 2 illustrates, as an example, a form in which one sentence punctuated by punctuation is treated as one document. However, one document may include a plurality of sentences.

The document management information 16A may be stored in an information processing apparatus outside the information processing apparatus 10. The external information processing apparatus in which the document management information 16A is stored is, for example, a web server or the like that provides a plurality of contents. In the present embodiment, a form in which the document management information 16A is stored in advance in the storage unit 16 of the information processing apparatus 10 will be described as an example.

Returning to FIG. 1, the description will be continued. Details of the first knowledge graph 16B, the second knowledge graph 16C, and the first representation vector management information 16D will be described later.

The control unit 20 is an arithmetic unit that executes information processing. The control unit 20 includes a first knowledge graph generating unit 20A, a second knowledge graph generating unit 20B, a representation vector calculating unit 20C, an acquisition unit 20D, a search word representation vector calculating unit 20E, a search document representation vector calculating unit 20F, a document search unit 20G, and an output control unit 20H.

At least one of the first knowledge graph generating unit 20A, the second knowledge graph generating unit 20B, the representation vector calculating unit 20C, the acquisition unit 20D, the search word representation vector calculating unit 20E, the search document representation vector calculating unit 20F, the document search unit 20G, and the output control unit 20H is implemented by, for example, one or a plurality of processors. For example, each of the above units may be implemented by causing a processor such as a CPU to execute a program, that is, by software. Each of the above units may be implemented by a processor such as a dedicated integrated circuit (IC), that is, hardware. Each of the above units may be implemented by using software and hardware in combination. In the case of using a plurality of processors, each processor may implement one of the respective units, or may implement two or more of the respective units.

The first knowledge graph generating unit 20A generates the first knowledge graph 16B.

The first knowledge graph 16B is a knowledge graph representing a relationship between each of all of a plurality of documents registered in the document management information 16A and a word included in each of the plurality of documents. The knowledge graph is a graph representing various kinds of information as knowledge, and is a graph created by describing a relationship between included elements. In the present embodiment, elements correspond to a plurality of words and a plurality of documents.

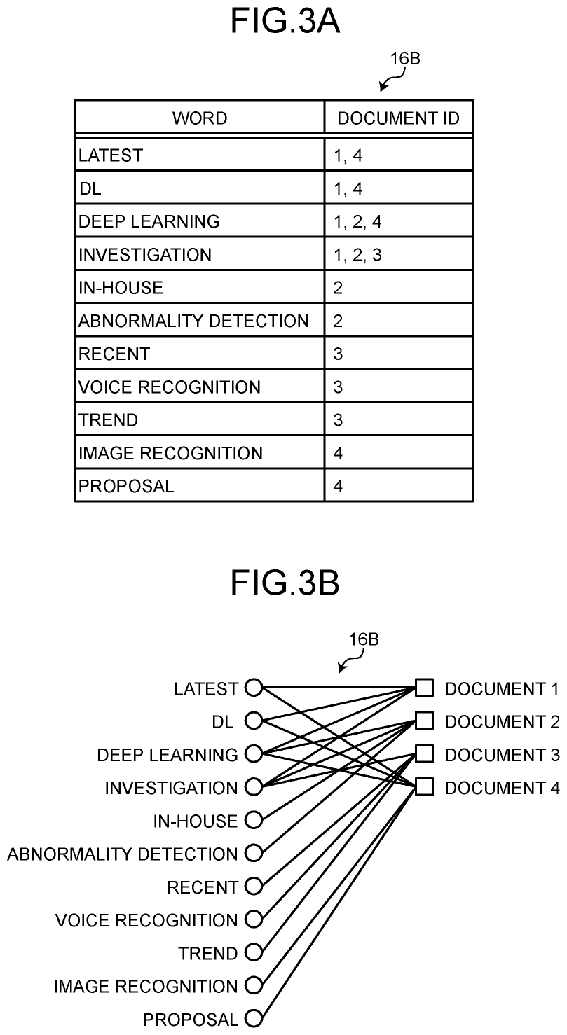

FIGS. 3A and 3B are schematic diagrams illustrating an example of a data configuration of the first knowledge graph 16B. As illustrated in FIGS. 3A and 3B, the first knowledge graph 16B is a graph representing a relationship between each of a plurality of words and a document including each word.

FIG. 3A is a schematic diagram illustrating the first knowledge graph 16B in a database format. As illustrated in FIG. 3A, for example, the first knowledge graph 16B is a database in which a word and a document ID of a document including the word are associated with each other. That is, the first knowledge graph 16B illustrated in FIG. 3A is a knowledge graph representing a relationship between a word and a document identified by a document ID in a database format. In the first knowledge graph 16B in the database format of FIG. 3A, the associated word and document ID have a relationship with each other.

FIG. 3B is a schematic diagram illustrating the first knowledge graph 16B in a graph format. As illustrated in FIG. 3B, the first knowledge graph 16B is represented by, for example, a bipartite graph including two types of vertexes of a word and a document ID. In the first knowledge graph 16B in the graph format of FIG. 3B, the word and the document ID associated by being linked to each other have a relationship with each other.

The first knowledge graph generating unit 20A extracts all the words included in each of all the documents registered in the document management information 16A. The first knowledge graph generating unit 20A may extract a word from a document by a known method. For example, the first knowledge graph generating unit 20A regards a partial string of the specified number of characters called an N-gram as a word and extracts the word by cutting out the word from the document. Furthermore, for example, the first knowledge graph generating unit 20A extracts a word by cutting out the word from the document using an arbitrary tokenizer. In addition, the first knowledge graph generating unit 20A may extract a word having an appearance frequency equal to or more than a specified number of times among the extracted words. In addition, the first knowledge graph generating unit 20A may selectively extract a word that is a morpheme that is a minimum language unit having a meaning from among the extracted words. For example, the first knowledge graph generating unit 20A may exclude non-morpheme words such as “desu” and “masu” in Japanese from among the extracted words.

Then, the first knowledge graph generating unit 20A generates the first knowledge graph 16B by associating the extracted word with the document ID of the document including the word. The first knowledge graph generating unit 20A may generate the first knowledge graph 16B by associating each of the plurality of extracted words with a document in which the word appears a specified number of times or more. In this case, the first knowledge graph generating unit 20A may be configured not to associate each of the plurality of extracted words with a document in which the word does not appear the specified number of times or more as not having a relationship. The specified number of times may be set in advance.

The first knowledge graph generating unit 20A stores the generated first knowledge graph 16B in the storage unit 16. The first knowledge graph generating unit 20A may store the generated first knowledge graph 16B in an external information processing apparatus. In the present embodiment, a mode in which the first knowledge graph generating unit 20A stores the first knowledge graph 16B in the storage unit 16 will be described as an example.

The second knowledge graph generating unit 20B generates the second knowledge graph 16C.

The second knowledge graph 16C is a knowledge graph representing a relationship between first words that are words included in each of all of a plurality of documents registered in the document management information 16A and documents including the first words. The first words are partial words among all words included in each of all of the plurality of documents registered in the document management information 16A. That is, the first words are partial words among the plurality of words registered in the first knowledge graph generating unit 20A. The first word is, for example, an important word among a plurality of words. In the present embodiment, the first word may be referred to as an important word.

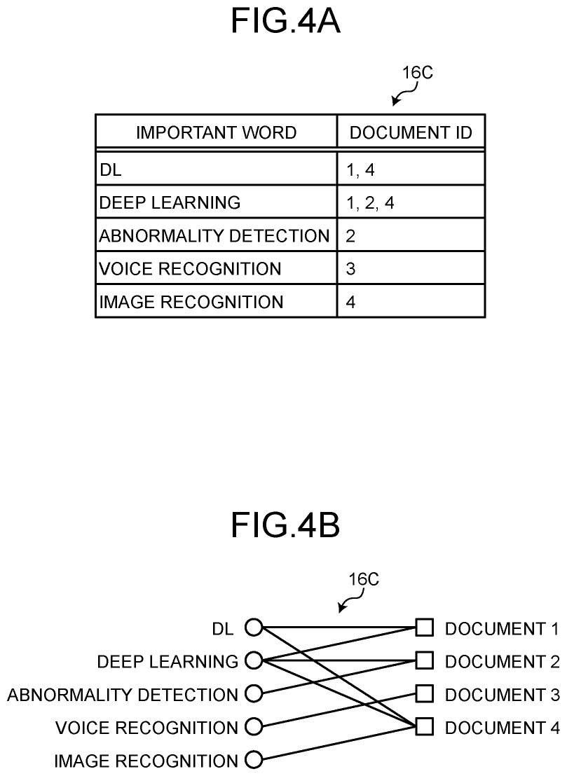

FIGS. 4A and 4B are schematic diagrams illustrating an example of a data configuration of the second knowledge graph 16C. As illustrated in FIGS. 4A and 4B, the second knowledge graph 16C is a graph representing a relationship between each of a plurality of important words and a document including each important word. As illustrated in FIGS. 4A and 4B, the important words registered in the second knowledge graph 16C are partial words among the plurality of words registered in the first knowledge graph 16B illustrated in FIGS. 3A and 3B.

FIG. 4A is a schematic diagram illustrating the second knowledge graph 16C in a database format. As illustrated in FIG. 4A, for example, the second knowledge graph 16C is a database in which an important word and a document ID of a document including the important word are associated with each other. That is, the second knowledge graph 16C illustrated in FIG. 4A is a knowledge graph representing the relationship between the important word and the document identified by the document ID in a database format. In the second knowledge graph 16C in the database format of FIG. 4A, the associated important word and document ID have a relationship with each other.

FIG. 4B is a schematic diagram illustrating the second knowledge graph 16C in a graph format. As illustrated in FIG. 4B, the second knowledge graph 16C is represented by, for example, a bipartite graph including two types of vertices of an important word and a document ID. In the second knowledge graph 16C in the graph format of FIG. 4B, the important word and the document ID associated by being linked to each other have a relationship with each other.

The second knowledge graph generating unit 20B generates the second knowledge graph 16C on the basis of the important word from the document management information 16A.

Specifically, the second knowledge graph generating unit 20B extracts all the words included in each of all the documents registered in the document management information 16A, similarly to the first knowledge graph generating unit 20A.

Then, the second knowledge graph generating unit 20B selects an important word from the plurality of extracted words.

For example, the second knowledge graph generating unit 20B selects a predetermined number of words in descending order of the number of appearances in the document management information 16A among the plurality of extracted words included in the document registered in the document management information 16A as important words.

Furthermore, for example, the second knowledge graph generating unit 20B may select words randomly selected from a plurality of extracted words included in the document registered in the document management information 16A as the important words.

Then, the second knowledge graph generating unit 20B generates the second knowledge graph 16C on the basis of the selected important words.

Specifically, the second knowledge graph generating unit 20B generates the second knowledge graph 16C by associating the selected important words with the document IDs of the documents including the important words. The second knowledge graph generating unit 20B may generate the second knowledge graph 16C by associating each of the selected important words with a document in which the important word appears a predetermined number of times or more. In other words, the second knowledge graph generating unit 20B may register, in the second knowledge graph, an important word that appears a predetermined number of times or more in the document registered in the document management information 16A among the selected important words in association with the document including the important word. In this case, the second knowledge graph generating unit 20B may be configured not to associate each of the plurality of selected important words with a document in which the important word does not appear a predetermined number of times or more as not having a relationship. The predetermined number of times may be set in advance.

The second knowledge graph generating unit 20B stores the generated second knowledge graph 16C in the storage unit 16. The second knowledge graph generating unit 20B may store the generated second knowledge graph 16C in an external information processing apparatus. In the present embodiment, a mode in which the second knowledge graph generating unit 20B stores the second knowledge graph 16C in the storage unit 16 will be described as an example.

Returning to FIG. 1, the description will be continued.

The representation vector calculating unit 20C calculates the important word representation vector of the important word and the document representation vector of the document on the basis of the second knowledge graph 16C, and registers the calculated vectors in the first representation vector management information 16D.

The important word representation vector is a representation vector of an important word. The important word representation vector is an example of the first word representation vector. The document representation vector is a representation vector of a document.

The representation vector is a distributed representation of a target. In the case of an important word representation vector, the target is an important word. In the case of a document representation vector, the target is a document. The representation vector is information representing a target by a plurality of features, and is represented by a multi-dimensional vector having a plurality of features as elements. The number of multidimensional dimensions is, for example, 768, but is not limited to this number of dimensions. By representing the targets by the representation vectors, the representation vectors of the targets indicate the closer values, as the targets are more semantically closer to each other. The representation vector is generated by learning such that targets having the same or similar meanings have more similar vectors.

The representation vector calculating unit 20C calculates an important word representation vector of each of the plurality of important words registered in the second knowledge graph 16C and a document representation vector of each of the documents identified by the document ID associated with the important word registered in the second knowledge graph 16C.

Specifically, the second knowledge graph generating unit 20B calculates the important word representation vector of the important word and the document representation vector of the document so as to hold the graph structure on the basis of the learning result of the graph structure represented by the relationship between the important word and the document registered in the second knowledge graph 16C. Holding the graph structure means holding the association between the important word represented by the second knowledge graph 16C and the document. As described above, in the representation vector, targets having the same or similar meanings have more similar vectors. In addition, words included in the same document tend to have similar representation vectors. Therefore, holding the graph structure represented by the second knowledge graph 16C means generating the important word representation vector and the document representation vector such that the calculated important word representation vector and the calculated document representation vector become the representation vector representing the relationship between the corresponding important word represented by the second knowledge graph 16C and the document.

The representation vector calculating unit 20C may use graph analysis techniques such as GNN (Graph Neural Network), which is deep learning for handling graphs, and matrix decomposition for learning of graph structures.

Specifically, for example, the representation vector calculating unit 20C generates an important word representation vector and a document representation vector by the following processing.

First, the representation vector calculating unit 20C specifies an important word registered in the second knowledge graph 16C and a document identified by a document ID corresponding to the important word. Then, the representation vector calculating unit 20C randomly initializes the representation vectors of the specified important words and documents.

Then, the representation vector calculating unit 20C calculates the first statistical representation vector of the representation vector of each of the documents including the important word for each important word registered in the second knowledge graph 16C. In addition, the representation vector calculating unit 20C calculates the second statistical representation vector of the representation vector of each of the important words included in the document for each document registered in the document management information 16A.

The first statistical representation vector is a statistical representation vector of the important word, and is a statistical value of the representation vector of each of the documents including the important word. The second statistical representation vector is a statistical representation vector of the document, and is a statistical value of the representation vector of each of the important words included in the document.

The statistical value is, for example, an average vector. In addition, the statistical value may be a maximum value of a vector value for each same dimension constituting the representation vector, a weighted average vector, or the like.

Through these processes, the representation vector calculating unit 20C calculates the first statistical representation vector of each of the important words registered in the second knowledge graph 16C and the second statistical representation vector of each of the documents registered in the document management information 16A.

Then, the representation vector calculating unit 20C corrects each of the representation vector of the document including the important word used to calculate the first statistical representation vector included in a pair of the calculated first statistical representation vector of the important word and the second statistical representation vector of the document and the representation vector of the important word included in the document used to calculate the second statistical representation vector included in the pair, such that the value of the objective function for each pair becomes the value representing the graph structure represented by the second knowledge graph 16C.

The objective function is a function for obtaining the degree of relationship between the important word registered in the second knowledge graph 16C and the document identified by the document ID associated with the important word. The value of the objective function is a value representing the degree of relationship between the important word and the document. In a case where the value of the objective function of a pair of the important word and the document associated in the second knowledge graph 16C is higher than the value of the objective function of a pair not associated in the second knowledge graph 16C, it can be said that the value of the objective function is a value along the graph structure of the second knowledge graph 16C.

For example, an inner product of the first statistical representation vector and the second statistical representation vector is used as the objective function. Examples of the objective function using the inner product include known BPR loss, 0, 1 loss, and the like. In addition, as the objective function, a learning model such as a neural network that outputs a value of the objective function satisfying the above condition may be used.

That is, the representation vector calculating unit 20C corrects the representation vectors using the objective function such that each of the representation vector of the important word and the representation vector of the document including the important word becomes a representation vector representing the graph structure represented by the second knowledge graph 16C.

Then, the representation vector calculating unit 20C repeats the calculation and the correction of the first statistical representation vector and the second statistical representation vector until the change between the representation vector before correction and the representation vector after correction is less than a predetermined value. The representation vector calculating unit 20C specifies the representation vector of the corrected important word when the change between the representation vector before correction and the representation vector after correction is less than a predetermined value as the important word representation vector. In addition, the representation vector calculating unit 20C specifies the representation vector of the corrected document when the change between the representation vector before correction and the representation vector after correction is less than a predetermined value as the document representation vector.

Through these processes, the representation vector calculating unit 20C calculates the important word representation vector of the important word and the document representation vector of the document so as to hold the graph structure represented by the relationship between the important word and the document registered in the second knowledge graph 16C.

The representation vector calculating unit 20C registers the calculated important word representation vector and document representation vector in the first representation vector management information 16D.

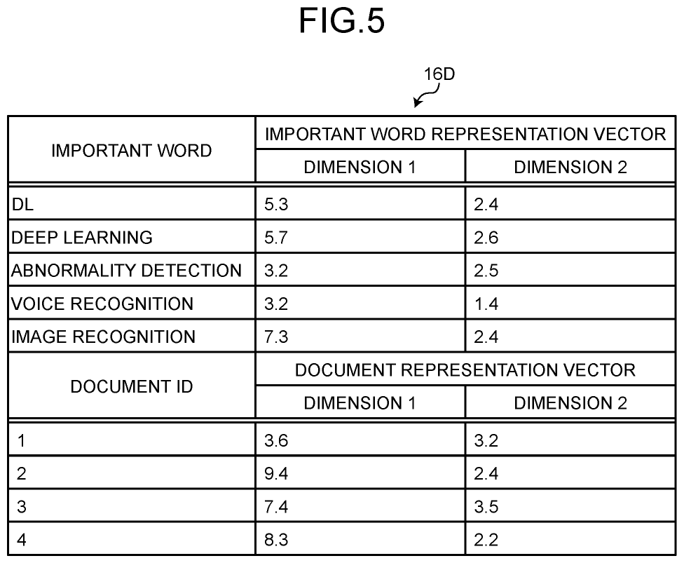

FIG. 5 is a schematic diagram illustrating an example of a data configuration of the first representation vector management information 16D. The representation vector calculating unit 20C registers the important word and the important word representation vector of the important word in association in the first representation vector management information 16D. In addition, the representation vector calculating unit 20C registers the document ID and the document representation vector of the document identified by the document ID in the first representation vector management information 16D in association with each other.

Therefore, in the first representation vector management information 16D, important word representation vectors of important words that are partial words among a plurality of words included in a plurality of documents registered in the document management information 16A are registered. In addition, the document representation vector of the document is registered in the first representation vector management information 16D.

Note that, in FIG. 5 and drawings to be described later, vector values for two dimensions are illustrated as dimensions of representation vectors such as important word representation vectors and document representation vectors. However, in practice, the number of dimensions of these representation vectors is, for example, the number of dimensions such as 768, and values of partial dimensions are illustrated in the drawing.

Returning to FIG. 1, the description will be continued.

The acquisition unit 20D acquires a search formula including a search word. As described above, the search word is a word serving as a keyword of the search specified by the user. The search formula includes at least the search word. The search formula may include a plurality of search words. In addition, the search formula may include a search condition. Examples of the search condition include AND search, NOT search, and the like. The AND search is a search condition for instructing search of documents related to the search word included in the search formula. The NOT search is a search condition for instructing exclusion of a document related to the search word included in the search formula from the search. When the search formula does not include the search condition, the control unit 20 is only required to process the search condition of the search word included in the search formula as the AND search or OR condition.

For example, the acquisition unit 20D acquires the search formula input by the operation of the UI unit 14 by the user from the UI unit 14. Furthermore, the acquisition unit 20D may acquire the search formula input by the operation by the user of an external information processing apparatus from the external information processing apparatus via the communication unit 12.

The search word representation vector calculating unit 20E calculates a search word representation vector on the basis of the first knowledge graph 16B, the second knowledge graph 16C, and the first representation vector management information 16D. The search word representation vector is a representation vector representing a distributed representation of the search word acquired by the acquisition unit 20D.

The search word representation vector calculating unit 20E calculates a search word representation vector for each of one or a plurality of search words included in the search formula acquired by the acquisition unit 20D.

Specifically, the search word representation vector calculating unit 20E specifies a document including the search word acquired by the acquisition unit 20D as a word from the first knowledge graph 16B. Then, the search word representation vector calculating unit 20E calculates the statistical representation vector of the document representation vector of the document registered in the first representation vector management information 16D among the specified documents as the search word representation vector of the search word. The statistical representation vector is a statistical value of the document representation vector of each of the plurality of documents including the search word as the important word.

Since the definition of the statistical value has been described above, the description thereof will be omitted here. As described above, the statistical value may be, for example, an average vector, a maximum value of vector values for each same dimension constituting the representation vector, a weighted average vector, or the like.

In addition, the statistical value may be a corrected representation vector in which a vector value of at least one dimension of the representation vector is corrected in accordance with a predetermined minimum value and maximum value. That is, the search word representation vector calculating unit 20E may calculate the corrected representation vector in which a vector value of the statistical representation vector is corrected in accordance with the predetermined minimum value and maximum value as the search word representation vector.

Through these processes, the search word representation vector calculating unit 20E calculates a search word representation vector for each of one or a plurality of search words included in the search formula acquired by the acquisition unit 20D. In other words, the search word representation vector calculating unit 20E calculates one search word representation vector for one search word.

The search document representation vector calculating unit 20F calculates a search document representation vector on the basis of the first knowledge graph 16B, the second knowledge graph 16C, and the first representation vector management information 16D.

The search document representation vector is a representation vector used for searching each of a plurality of documents registered in the first knowledge graph 16B, and is a representation vector representing distributed representation of each of the documents. The first knowledge graph 16B is a knowledge graph representing a relationship between each document ID and a word of all the documents registered in the document management information 16A. Therefore, in other words, the search document representation vector is a representation vector used for searching each of all the documents registered in the document management information 16A.

The search document representation vector calculating unit 20F specifies, for each of a plurality of documents registered in the document management information 16A, an important word associated with the document in the second knowledge graph 16C. Then, the search document representation vector calculating unit 20F specifies the important word representation vector of the specified important word from the first representation vector management information 16D. Further, the search document representation vector calculating unit 20F calculates the statistical representation vector of the important word representation vector specified for each of the documents as the search document representation vector. The statistical representation vector is a statistical value of the important word representation vector specified for each of the plurality of documents registered in the document management information 16A.

Since the definition of the statistical value has been described above, the description thereof will be omitted here. As described above, the statistical value may be, for example, an average vector, a maximum value of vector values for each same dimension constituting the representation vector, a weighted average vector, or the like.

Similarly to the above, the statistical value may be a corrected representation vector in which the vector value of at least one dimension of the representation vector is corrected in accordance with the predetermined minimum value and maximum value. That is, the search document representation vector calculating unit 20F may calculate the corrected representation vector in which the vector value of the statistical representation vector is corrected in accordance with the predetermined minimum value and maximum value as the search document representation vector.

Through these processes, the search document representation vector calculating unit 20F calculates the search document representation vector for each of the plurality of documents registered in the document management information 16A. In other words, the search word representation vector calculating unit 20E calculates a plurality of search document representation vectors from the document management information 16A.

The document search unit 20G searches the document represented by the search document representation vector included in a combination of the search word representation vector calculated by the search word representation vector calculating unit 20E and each of the plurality of search document representation vectors calculated by the search document representation vector calculating unit 20F as the search result of the search word in accordance with the score representing the degree of relevance for each combination.

The score is one search word representation vector, one search document representation vector, and an index indicating the degree of relevance of a combination including a pair. The score is represented by, for example, an inner product of the search word representation vector and the search document representation vector. Furthermore, the score may be an average vector of the search word representation vector and the search document representation vector, a maximum value of vector values for each same dimension, a weighted average vector, or the like. Similarly to the statistical value, the score may be a corrected representation vector in which a vector value of at least one dimension of a representation vector represented by an inner product or an average vector of the search word representation vector and the search document representation vector is corrected in accordance with a predetermined minimum value and maximum value.

For example, the document search unit 20G searches, as a search result, a document represented by a search document representation vector included in a combination satisfying at least one of conditions of a predetermined number in descending order of scores and a score equal to or greater than a predetermined threshold.

Note that the search formula may be included in the search formula acquired by the acquisition unit 20D.

In a case where the search condition included in the acquired search formula represents the AND search, the document search unit 20G may calculate a higher score for each combination of the search word representation vector and the plurality of search document representation vectors as the degree of relevance is higher. Furthermore, in a case where a plurality of search words are included in the search formula including the AND search, the document search unit 20G may use the sum or product of the scores calculated for each combination of the search word representation vector and the plurality of search document representation vectors as the score used for determining whether or not to use the sum or product as the search result document.

In a case where the search condition included in the acquired search formula represents the NOT search, the document search unit 20G is only required to calculate the score for each of the plurality of combinations each combination using an inverse vector in which the direction of the vector of each of the search word representation vector and the document representation vector included in each of the combinations is reversed. That is, the document search unit 20G is only required to calculate a higher score as the degree of relevance between the search word and the document is lower for each of the combinations of the search word representation vector and the plurality of search document representation vectors by using the inverse vector.

Then, the document search unit 20G may search, as a search result, a document represented by a search document representation vector included in a combination satisfying at least one of conditions of a predetermined number in descending order of scores and a score equal to or greater than a predetermined threshold.

This threshold may be determined in advance. For example, the document search unit 20G specifies a combination including a search document representation vector of a document including the search word among a plurality of combinations. Then, the document search unit 20G is only required to determine a threshold in accordance with the score of the specified combination. In a case where the number of specified combinations is one, the document search unit 20G is only required to determine the score of the one specified combination as the threshold. Furthermore, in a case where there are a plurality of specified combinations, the document search unit 20G is only required to determine a lower limit value, an average value, or a median value of the scores of each of the plurality of specified combinations as the threshold.

Furthermore, the document search unit 20G may determine the threshold in accordance with the distribution of the scores of each of a plurality of combinations. For example, the document search unit 20G is only required to determine, as the threshold, a lower limit value, an average value, or a median value of a group of scores that occupy the top several percentages among the scores of the plurality of combinations. The value of several percents may be set in advance.

In addition, the document search unit 20G may correct the score such that the score of a value less than the threshold among the scores calculated for each combination becomes a value of −∞ as a combination that is not related to the search word at all.

Note that, in a case where the search condition included in the acquired search formula represents the NOT search, the document search unit 20G may calculate the score for each combination using the search word representation vector and the document representation vector without using the inverse vector.

In this case, in a case where the search condition included in the acquired search formula represents the NOT search, the document search unit 20G is only required to search, as the search result, a document represented by the search document representation vector included in a combination satisfying at least one of conditions of a predetermined number in ascending order of scores and a score less than a predetermined threshold. In addition, in a case where the search condition included in the acquired search formula represents the AND search, it is only required to search, as the search result, a document represented by the search document representation vector included in a combination satisfying at least one of conditions of a predetermined number in descending order of scores and a score equal to or greater than a predetermined threshold.

The output control unit 20H outputs a search result by the document search unit 20G. The output control unit 20H outputs the search result to the device from which the search formula used for document search is acquired. For example, a scene is assumed in which the acquisition unit 20D acquires the search formula input by the operation of the UI unit 14 by the user from the UI unit 14. In this case, the output control unit 20H outputs the search result to the UI unit 14. The user can check the search result by checking at least one of the display and the speaker of the UI unit 14. Furthermore, for example, a scene in which the acquisition unit 20D acquires the search formula input by the operation by the user of the external information processing apparatus from the external information processing apparatus is stayed. In this case, the output control unit 20H outputs the search result to the external information processing apparatus via the communication unit 12. The user can check the search result received from the output control unit 20H by operating the external information processing apparatus.

It is only required that the search result is information including at least a document specified in accordance with the score as a document related to the search word. In addition, the output control unit 20H may output a search result including at least one of the document searched as the search result of the search word, the score of the combination including the search document representation vector of the searched document, and the related word which is the word included in the searched document.

Next, an example of a flow of information processing executed by the information processing apparatus 10 according to the present embodiment will be described.

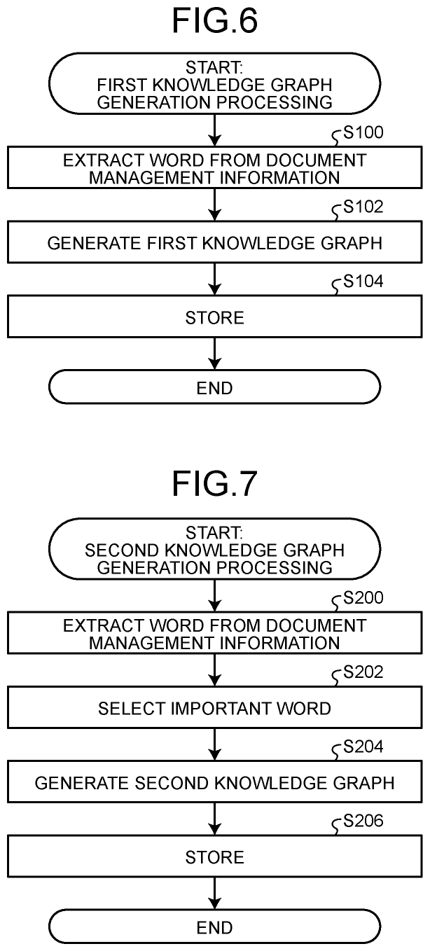

FIG. 6 is a flowchart illustrating an example of a flow of generation processing of the first knowledge graph 16B.

The first knowledge graph generating unit 20A extracts all the words included in each of all the documents registered in the document management information 16A (step S100).

The first knowledge graph generating unit 20A generates the first knowledge graph 16B by associating each of the plurality of words extracted in step S100 with the document ID of the document including the word (step S102). Then, the first knowledge graph generating unit 20A stores the first knowledge graph 16B generated in step S102 in the storage unit 16 (step S104). Then, this routine is ended.

FIG. 7 is a flowchart illustrating an example of a flow of generation processing of the second knowledge graph 16C.

The second knowledge graph generating unit 20B extracts all the words included in each of all the documents registered in the document management information 16A (step S200).

The second knowledge graph generating unit 20B selects an important word from the plurality of words extracted in step S200 (step S202).

The second knowledge graph generating unit 20B generates the second knowledge graph 16C by associating the important word selected in Step S202 with the document ID of the document including the important word (Step S204). Then, the second knowledge graph generating unit 20B stores the second knowledge graph 16C generated in step S204 in the storage unit 16 (step S206). Then, this routine is ended.

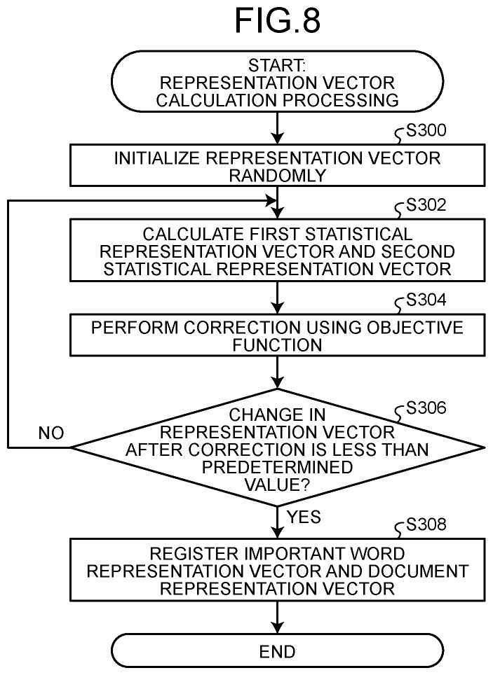

FIG. 8 is a flowchart illustrating an example of a flow of representation vector calculation processing by the representation vector calculating unit 20C.

The representation vector calculating unit 20C specifies an important word registered in the second knowledge graph 16C and a document identified by a document ID corresponding to the important word. Then, the representation vector calculating unit 20C randomly initializes the representation vectors of the specified important words and documents (step S300).

The representation vector calculating unit 20C calculates the first statistical representation vector and the second statistical representation vector (step S302). In step S302, the representation vector calculating unit 20C calculates, for each important word registered in the second knowledge graph 16C, a first statistical representation vector that is a statistical value of a representation vector of each document including the important word. In addition, the representation vector calculating unit 20C calculates, for each document registered in the document management information 16A, a second statistical representation vector that is a statistical value of a representation vector of each important word included in the document.

The representation vector calculating unit 20C corrects each of the representation vector of the document including the important word used to calculate the first statistical representation vector included in a pair of the first statistical representation vector of the important word and the second statistical representation vector of the document calculated in step S302 and the representation vector of the important word included in the document used to calculate the second statistical representation vector included in the pair such that the value of the objective function for each pair becomes the value representing the graph structure represented by the second knowledge graph 16C (step S304).

The representation vector calculating unit 20C determines whether or not a change between the representation vector after the correction in step S304 and the representation vector before the correction in step S304 is less than a predetermined value (step S306). When a negative determination is made in step S306 (step S306: No), the process returns to step S302. When an affirmative determination is made in step S306 (step S306: Yes), the process proceeds to step S308.

In step S308, the representation vector calculating unit 20C registers the important word representation vector and the document representation vector in the first representation vector management information 16D (step S308). Then, this routine is ended.

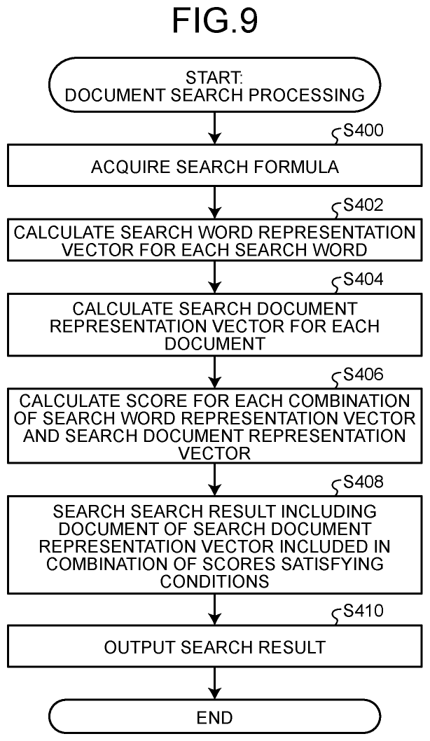

FIG. 9 is a flowchart illustrating an example of a flow of the document search processing.

The acquisition unit 20D acquires a search formula including the search word (step S400).

On the basis of the first knowledge graph 16B, the second knowledge graph 16C, and the first representation vector management information 16D, the search word representation vector calculating unit 20E calculates a search word representation vector for each of one or a plurality of search words included in the search formula acquired in step S400 (step S402).

Specifically, the search word representation vector calculating unit 20E specifies a document including the search word acquired in step S400 as a word from the first knowledge graph 16B. Then, the search word representation vector calculating unit 20E calculates the statistical representation vector of the document representation vector of the document registered in the first representation vector management information 16D among the specified documents as the search word representation vector of the search word.

On the basis of the first knowledge graph 16B, the second knowledge graph 16C, and the first representation vector management information 16D, the search document representation vector calculating unit 20F calculates a search document representation vector for each of the documents registered in the document management information 16A (step S404).

Specifically, the search document representation vector calculating unit 20F specifies, for each of a plurality of documents registered in the document management information 16A, an important word associated with the document in the second knowledge graph 16C. Then, the search document representation vector calculating unit 20F specifies the important word representation vector of the specified important word from the first representation vector management information 16D. Further, the search document representation vector calculating unit 20F calculates the statistical representation vector of the important word representation vector specified for each of the documents as the search document representation vector.

The document search unit 20G calculates a score representing the degree of relevance for each combination of one or a plurality of search word representation vectors calculated in step S402 and each of the plurality of search document representation vectors calculated in step S404 (step S406). Then, the document search unit 20G searches the document represented by the search document representation vector included in the combination as the search result of the search word in accordance with the score calculated in step S406 (step S408).

The output control unit 20H outputs the search result of step S408 (step S410). Then, this routine is ended.

As described above, the search word representation vector calculating unit 20E of the information processing apparatus 10 according to the present embodiment calculates the search word representation vector of the search word on the basis of the first knowledge graph 16B representing the relationship between a document registered in the document management information 16A and a word included in the document, the second knowledge graph 16C representing the relationship between an important word (first word), which is the word included in the document, and a document including the important word, and the first representation vector management information 16D in which an important word representation vector (first word representation vector) of the important word and a document representation vector of the document including the important word are registered. On the basis of the first knowledge graph 16B, the second knowledge graph 16C, and the first representation vector management information 16D, the search document representation vector calculating unit 20F calculates a search document representation vector used for searching a plurality of documents registered in the document management information 16A. On the basis of a combination of the search word representation vector and the plurality of search document representation vectors, the document search unit 20G searches a document represented by the search document representation vector included in the combination.

As described above, the information processing apparatus 10 according to the present embodiment calculates the search word representation vector of the search word using the relationship between the word and the document represented by the first knowledge graph 16B and the second knowledge graph 16C and the document representation vector registered in the first representation vector management information 16D. In addition, the information processing apparatus 10 according to the present embodiment calculates the search document representation vector of the document registered in the document management information 16A using the relationship between the word and the document represented by the first knowledge graph 16B and the second knowledge graph 16C and the important word representation vector registered in the first representation vector management information 16D. Then, the information processing apparatus 10 searches the document on the basis of a combination of the important word representation vector and the search document representation vector.

Therefore, the information processing apparatus 10 of the present embodiment can calculate the search word representation vector of the search word and the search document representation vector of the document registered in the document management information 16A at a low load and at a high speed according to the search word included in the acquired search formula. In addition, the information processing apparatus 10 can easily search a document related to the search word from all the documents registered in the document management information 16A by using the search word representation vector and the search document representation vector calculated by acquiring the search formula.

Therefore, the information processing apparatus 10 of the present embodiment can enable document search with a wide range of search words.

In addition, the information processing apparatus 10 according to the present embodiment calculates a search word representation vector of the search word and a search document representation vector of the document registered in the document management information 16A according to the search word included in the acquired search formula. For this reason, the information processing apparatus 10 of the present embodiment does not need to calculate and store in advance the search document representation vector and the search word representation vector for each of the documents to be used for searching a huge amount of a plurality of documents registered in the document management information 16A.

Therefore, in addition to the above effects, the control unit 20 of the present embodiment can easily calculate the search word representation vector and the search document representation vector of the large-scale search words with limited calculation resources.

### Second Embodiment

In the present embodiment, a mode in which the second statistical representation vector for each document calculated at the time of calculating the document representation vector is stored and used at the time of calculating the search document representation vector will be described. In the present embodiment, the same components as those in the above embodiment are denoted by the same reference numerals, and the description thereof may be omitted.

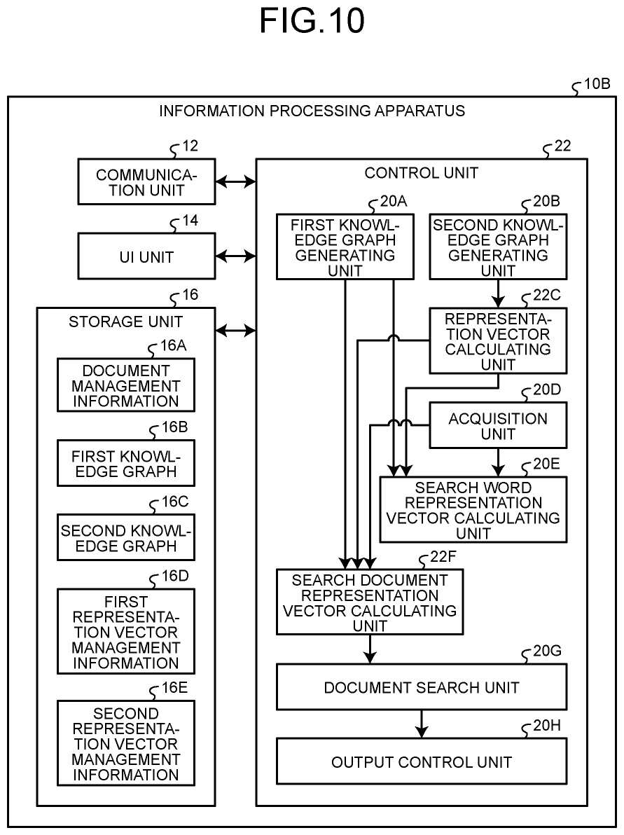

FIG. 10 is a diagram illustrating an example of a functional configuration of an information processing apparatus 10B according to the present embodiment.

The information processing apparatus 10B includes a communication unit 12, a UI unit 14, a storage unit 16, and a control unit 22. The communication unit 12, the UI unit 14, the storage unit 16, and the control unit 22 are communicably connected by a bus or the like.

The information processing apparatus 10B is similar to the information processing apparatus 10 of the above embodiment except that the storage unit 16 further stores a second representation vector management information 16E and includes the control unit 22 instead of the control unit 20.

The control unit 22 is an arithmetic unit that executes information processing. The control unit 22 includes a first knowledge graph generating unit 20A, a second knowledge graph generating unit 20B, a representation vector calculating unit 22C, an acquisition unit 20D, a search word representation vector calculating unit 20E, a search document representation vector calculating unit 22F, a document search unit 20G, and an output control unit 20H. The control unit 22 is similar to the control unit 20 of the above embodiment except that a representation vector calculating unit 22C and a search document representation vector calculating unit 22F are included instead of the representation vector calculating unit 20C and the search document representation vector calculating unit 20F.

Similarly to the representation vector calculating unit 20C, the representation vector calculating unit 22C calculates the important word representation vector of the important word and the document representation vector of the document on the basis of the second knowledge graph 16C, and registers them in the first representation vector management information 16D.

In the present embodiment, the representation vector calculating unit 22C further registers the second statistical representation vector calculated at the time of calculating the important word representation vector of the important word and the document representation vector of the document in the second representation vector management information 16E. As described above, the second statistical representation vector is calculated for each document registered in the document management information 16A, and is a statistical value of the representation vector of each important word included in the document.

That is, the representation vector calculating unit 22C calculates the first statistical representation vector of each of the important words registered in the second knowledge graph 16C and the second statistical representation vector of each of the documents registered in the document management information 16A, similarly to the representation vector calculating unit 20C. Then, similarly to the representation vector calculating unit 20C, the representation vector calculating unit 22C corrects each of the representation vector of the document including the important word used to calculate the first statistical representation vector included in a pair of the calculated first statistical representation vector of the important word and the second statistical representation vector of the document and the representation vector of the important word included in the document used to calculate the second statistical representation vector included in the pair such that the value of the objective function for each pair becomes the value representing the graph structure represented by the second knowledge graph 16C.

Then, similarly to the representation vector calculating unit 20C, the representation vector calculating unit 22C repeats the calculation and the correction of the first statistical representation vector and the second statistical representation vector until the change between the representation vector before correction and the representation vector after correction becomes less than a predetermined value. The representation vector calculating unit 22C specifies the representation vector of the important word after correction when the change between the representation vector before correction and the representation vector after correction is less than a predetermined value as the important word representation vector. In addition, the representation vector calculating unit 22C specifies the representation vector of the document after correction when the change between the representation vector before correction and the representation vector after correction is less than a predetermined value as the document representation vector.

Then, the representation vector calculating unit 22C of the present embodiment further registers the second statistical representation vector of each of the documents in the second representation vector management information 16E in association with the document ID of the document when the change between the representation vector before correction and the representation vector after correction is less than a predetermined value.

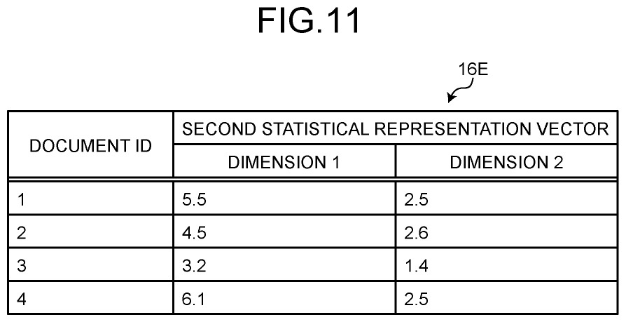

FIG. 11 is a schematic diagram of an example of a data configuration of the second representation vector management information 16E. The second representation vector management information 16E is a database in which the document ID and the statistical representation vector are associated with each other. The data configuration of the second representation vector management information 16E is not limited to the database.

Returning to FIG. 10, the description will be continued.

The search document representation vector calculating unit 22F specifies the second statistical representation vector corresponding to each of the plurality of documents registered in the document management information 16A from the second representation vector management information 16E, and calculates the specified second statistical representation vector as the search document representation vector.

Next, an example of a flow of information processing executed by the information processing apparatus 10B according to the present embodiment will be described.

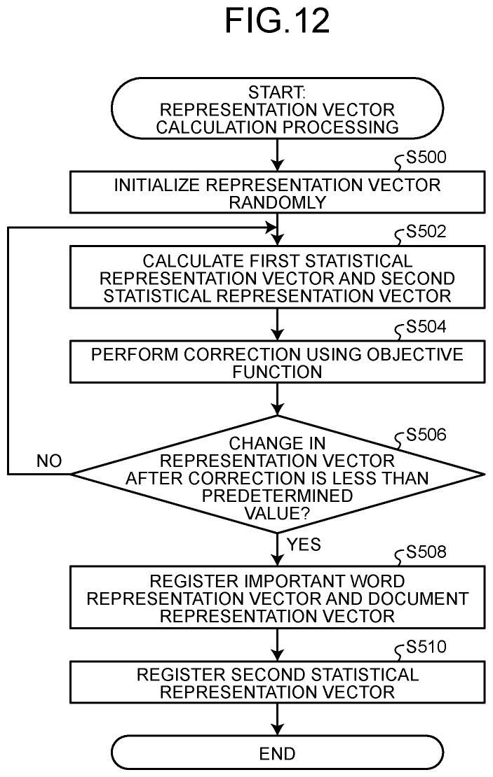

FIG. 12 is a flowchart illustrating an example of a flow of representation vector calculation processing by the representation vector calculating unit 22C.

The representation vector calculating unit 22C performs the processing of steps S500 to S508 similarly to the representation vector calculating unit 20C. Steps S500 to S508 are similar to steps S300 to S308 illustrated in FIG. 8.

Then, the representation vector calculating unit 22C registers the second statistical representation vector calculated for each document in step S502 in the second representation vector management information 16E in association with the document ID of the document (step S510). Then, this routine is ended.

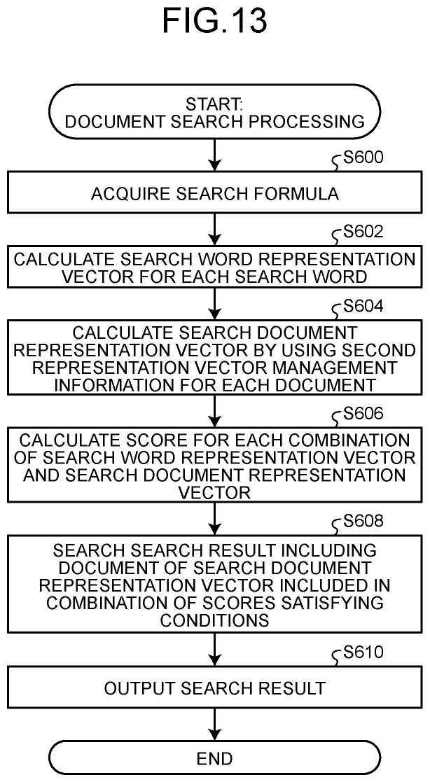

FIG. 13 is a flowchart illustrating an example of a flow of the document search processing.

The acquisition unit 20D acquires a search formula including the search word (step S600). On the basis of the first knowledge graph 16B, the second knowledge graph 16C, and the first representation vector management information 16D, the search word representation vector calculating unit 20E calculates a search word representation vector for each of one or a plurality of search words included in the search formula acquired in step S600 (step S602). The processing in steps S600 and S602 is similar to each of steps S400 and S402 described with reference to FIG. 9.

The search document representation vector calculating unit 22F specifies the second statistical representation vector corresponding to each of the plurality of documents registered in the document management information 16A from the second representation vector management information 16E. Then, the search document representation vector calculating unit 22F calculates the specified second statistical representation vector as the search document representation vector (step S604).

The document search unit 20G calculates a score for each combination of one or a plurality of search word representation vectors calculated in step S602 and each of the plurality of search document representation vectors calculated in step S604 (step S606). Then, the document search unit 20G searches the document represented by the search document representation vector included in the combination as the search result of the search word in accordance with the score calculated in step S606 (step S608). The output control unit 20H outputs the search result of step S608 (step S610). Steps S606 to S610 are similar to steps S406 to S410 in FIG. 9. Then, this routine is ended.

As described above, in the information processing apparatus 10B according to the present embodiment, the representation vector calculating unit 22C further registers the second statistical representation vector calculated for each document at the time of calculating the important word representation vector and the document representation vector in the second representation vector management information 16E. The search document representation vector calculating unit 22F specifies the second statistical representation vector corresponding to each of the plurality of documents registered in the document management information 16A from the second representation vector management information 16E, and calculates the specified second statistical representation vector as the search document representation vector.

In the first embodiment, the search document representation vector calculating unit 20F specifies, for each of a plurality of documents registered in the document management information 16A, an important word associated with the document in the second knowledge graph 16C. Then, the search document representation vector calculating unit 20F specifies the important word representation vector of the specified important word from the first representation vector management information 16D. Further, the search document representation vector calculating unit 20F calculates the statistical representation vector of the important word representation vector specified for each of the documents as the search document representation vector. Through these processes, the search document representation vector calculating unit 20F calculates the search document representation vector for each of the plurality of documents registered in the document management information 16A.

Here, as compared with the number of words registered in the document management information 16A, the number of documents is about several tens of thousands to several hundreds of thousands, which is relatively small in practice in many cases.

Therefore, in the present embodiment, the representation vector calculating unit 22C registers the second statistical representation vector corresponding to each of the plurality of documents registered in the document management information 16A in the second representation vector management information 16E in advance. Then, the search document representation vector calculating unit 22F specifies the second statistical representation vector corresponding to each of the plurality of documents registered in the document management information 16A from the second representation vector management information 16E, and calculates the specified second statistical representation vector as the search document representation vector.

Therefore, the information processing apparatus 10B of the present embodiment can reduce the calculation load of the search document representation vector and shorten the processing time thereof.

Therefore, the information processing apparatus 10B of the present embodiment can search a document related to the search word at a high speed in addition to the effects of the above embodiment.

### Third Embodiment

In the present embodiment, a mode of selecting an important word from the document management information 16A by a method different from the above-described embodiment will be described. In the present embodiment, the same components as those in the above embodiment are denoted by the same reference numerals, and the description thereof may be omitted.

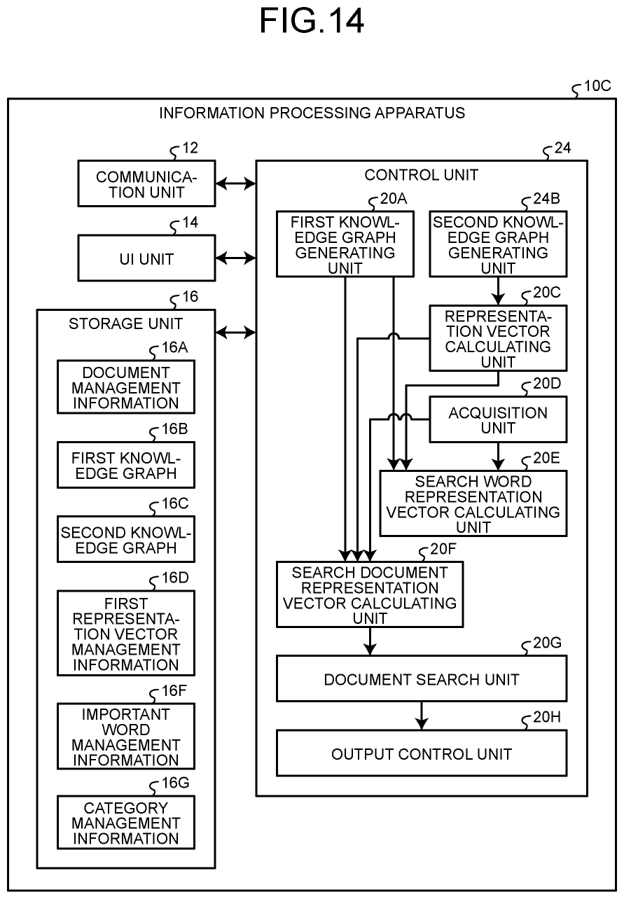

FIG. 14 is a diagram illustrating an example of a functional configuration of an information processing apparatus 10C of the present embodiment.

The information processing apparatus 10C includes a communication unit 12, a UI unit 14, a storage unit 16, and a control unit 24. The communication unit 12, the UI unit 14, the storage unit 16, and the control unit 24 are communicably connected by a bus or the like.

The information processing apparatus 10C is similar to the information processing apparatus 10 of the above embodiment except that the storage unit 16 further stores important word management information 16F and category management information 16G, and includes the control unit 24 instead of the control unit 20.

The control unit 24 is an arithmetic unit that executes information processing. The control unit 24 includes a first knowledge graph generating unit 20A, a second knowledge graph generating unit 24B, a representation vector calculating unit 20C, an acquisition unit 20D, a search word representation vector calculating unit 20E, a search document representation vector calculating unit 20F, a document search unit 20G, and an output control unit 20H. The control unit 24 is similar to the control unit 20 of the above embodiment except that a second knowledge graph generating unit 24B is provided instead of the second knowledge graph generating unit 20B.

The second knowledge graph generating unit 24B generates the second knowledge graph 16C similarly to the second knowledge graph generating unit 20B. The second knowledge graph generating unit 24B selects an important word by a method different from that of the second knowledge graph generating unit 20B.

For example, the second knowledge graph generating unit 24B selects an important word using the important word management information 16F.

The important word management information 16F is a database in which a designated important word designated in advance is registered. The data format of the important word management information 16F is not limited to the database. For example, the second knowledge graph generating unit 24B registers a word designated by the user or the like in advance as a designated important word in the important word management information 16F. Furthermore, for example, the second knowledge graph generating unit 24B may register a word included in an index of a dictionary which is an example of a document, a search word acquired in the past by the acquisition unit 20D, or the like in advance in the important word management information 16F as a designated important word.

The second knowledge graph generating unit 24B selects, as an important word, a word matching the designated important word registered in the important word management information 16F among the words included in the document registered in the document management information 16A.

In this case, the second knowledge graph generating unit 24B can select a word designated in advance by the user or the like as the important word.

In addition, the second knowledge graph generating unit 24B may select, as the important word, a predetermined number of words in descending order of the number of matches with the designated important words registered in the important word management information 16F among the words included in the document registered in the document management information 16A.

In this case, the second knowledge graph generating unit 24B can select, as the important word, a word designated in advance and used in a large amount in the document management information 16A, that is, a word having a high appearance frequency.

In addition, the second knowledge graph generating unit 24B may select, as the important word, a word acquired by the acquisition unit 20D as a search word in the past among the words included in the document registered in the document management information 16A. In this case, the second knowledge graph generating unit 24B is only required to register the search word acquired by the acquisition unit 20D in the document management information 16A in advance as the designated important word. In addition, the second knowledge graph generating unit 24B may register the search word acquired a predetermined number of times or more among the search words acquired by the acquisition unit 20D in the document management information 16A in advance as the designated important word.

In this case, the second knowledge graph generating unit 24B can select the important word corresponding to the search word to be searched by the user.

In addition, the second knowledge graph generating unit 24B may select the important word using the category management information 16G.

The category management information 16G is a database in which a word included in the document registered in the document management information 16A is associated with one or a plurality of categories to which the document including the word belongs. The data format of the category management information 16G is not limited to the database. The category corresponds to a label representing each group when a plurality of documents are classified into a plurality of groups according to a predetermined condition. The category is, for example, a field to which the document belongs. Specifically, for example, a case is assumed where the type of the document is a paper. In this case, a field to which a paper belongs, for example, a mechanical paper, an information paper, or the like corresponds to a category.

In this case, the second knowledge graph generating unit 24B selects, as the important word, a word biased-appearing in the document of the specific category among the words included in the document registered in the document management information 16A.

For example, a word frequently used in a specific field is likely to be a technical term. On the other hand, a word used substantially uniformly in various fields is likely to be a general term. Therefore, the second knowledge graph generating unit 24B selects a word biased-appearing in a document of a specific category among words included in the document registered in the document management information 16A as an important word, such that the information processing apparatus 10B can search more detailed documents related to the specialized field.

For example, entropy may be used as an index for quantitatively determining a degree of bias of appearance in a document of a specific category. Note that the index for achieving the degree of bias is not limited to entropy.

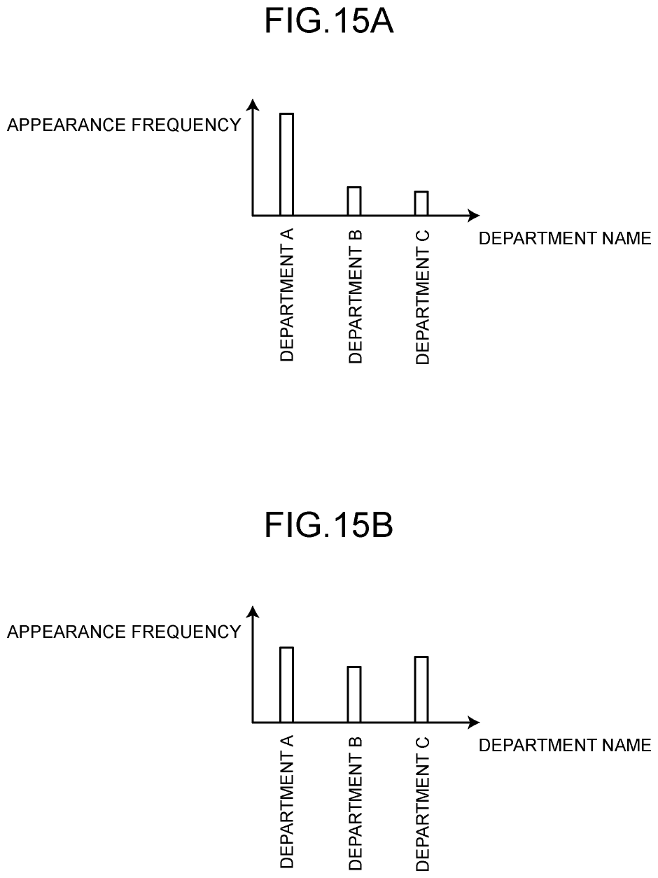

FIG. 15A is an explanatory diagram of an example of a word with low entropy. FIG. 15A illustrates appearance frequencies of a certain word for each of a plurality of categories “department A”, “department B”, and “department C”. The word illustrated in FIG. 15A biased-appears in the category “department A” and has low entropy.

FIG. 15B is an explanatory diagram of an example of a word having high entropy. FIG. 15B illustrates appearance frequencies of a certain word for each of the plurality of categories “department A”, “department B”, and “department C”. The word represented by FIG. 15B appears substantially uniformly in each of the categories “department A”, “department B”, and “department C”, and has high entropy.

Therefore, the second knowledge graph generating unit 24B calculates entropy representing the degree of bias to the document of the specific category for each of the words included in the document registered in the document management information 16A.

Then, the second knowledge graph generating unit 24B specifies a word having entropy of a predetermined value or less as a word biased-appearing in a document of a specific category, and selects the word as an important word.

In this case, the second knowledge graph generating unit 24B can select, as the important word, a word such as a technical term having a high frequency of appearance in a document of a specific category.

Then, similarly to the second knowledge graph generating unit 20B, the second knowledge graph generating unit 24B is only required to generate the second knowledge graph 16C representing the relationship between the selected important word and the document including the important word, and store the second knowledge graph 16C in the storage unit 16.

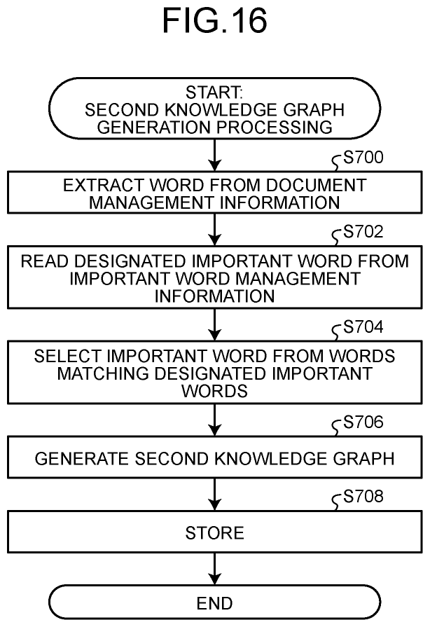

FIG. 16 is a flowchart illustrating an example of a flow of generation processing of the second knowledge graph 16C. FIG. 16 illustrates an example in which the second knowledge graph generating unit 24B selects an important word using the important word management information 16F.

The second knowledge graph generating unit 24B extracts all the words included in each of all the documents registered in the document management information 16A (step S700).

The second knowledge graph generating unit 24B reads the designated important word registered in the important word management information 16F (step S702).

The second knowledge graph generating unit 24B selects, as the important word, a word matching the designated important word registered in the important word management information 16F read in step S702 among the words extracted in step S700 (step S704). The second knowledge graph generating unit 24B may select, as the important word, a predetermined number of words in descending order of the number of matches with the designated important words registered in the important word management information 16F among the words included in the document registered in the document management information 16A.

In this case, the second knowledge graph generating unit 24B can select, as the important word, a word designated in advance and used in a large amount in the document management information 16A, that is, a word having a high appearance frequency.

The second knowledge graph generating unit 24B generates the second knowledge graph 16C by associating the important word selected in step S704 with the document ID of the document including the important word (step S706). Then, the second knowledge graph generating unit 24B stores the second knowledge graph 16C generated in step S706 in the storage unit 16 (step S708). Then, this routine is ended.

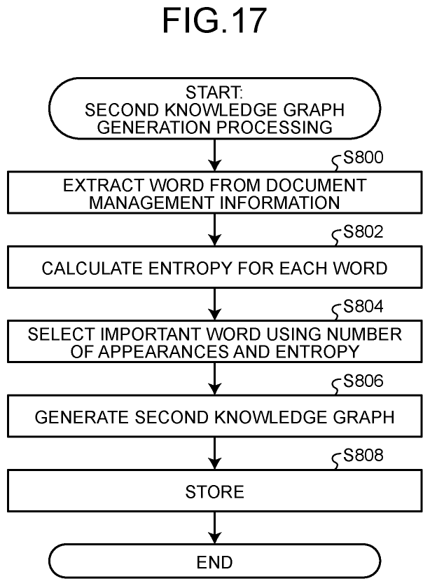

FIG. 17 is a flowchart illustrating an example of a flow of generation processing of the second knowledge graph 16C. FIG. 17 illustrates, as an example, a case in which the second knowledge graph generating unit 24B selects an important word using the category management information 16G.

The second knowledge graph generating unit 24B extracts all the words included in each of all the documents registered in the document management information 16A (step S800).

The second knowledge graph generating unit 24B calculates entropy using the category management information 16G for each of the words extracted in step S800 (step S802).

The second knowledge graph generating unit 24B selects, as the important word, a word in which the total number of appearances in all the documents registered in the document management information 16A is equal to or more than a predetermined number of times and the entropy calculated in step S802 is equal to or less than a predetermined value among the words extracted in step S800 (step S804). By the processing in step S804, the second knowledge graph generating unit 24B can select a word such as a technical term biased-appearing in a document of a specific category and frequently appearing in the document as an important word.

The second knowledge graph generating unit 24B generates the second knowledge graph 16C by associating the important word selected in step S804 with the document ID of the document including the important word (step S806). Then, the second knowledge graph generating unit 24B stores the second knowledge graph 16C generated in step S806 in the storage unit 16 (step S808). Then, this routine is ended.

As described above, the information processing apparatus 10C of the present embodiment selects, as the important word, a word that satisfies at least one of a word that matches the designated important word registered in the important word management information 16F, a word acquired as the search word in the past, a word biased-appearing in the document of the specific category, and a word having a high appearance frequency in the document management information 16A among the words included in the document registered in the document management information 16A.

Therefore, the information processing apparatus 10C of the present embodiment can effectively select an appropriate important word from the document in which the document management information 16A is registered.

Therefore, the information processing apparatus 10C of the present embodiment can enable more effective document search in addition to the effects of the above embodiment.

### Fourth Embodiment

In the present embodiment, a mode for efficiently generating a search document representation vector for a new document not registered in the document management information 16A will be described. In the present embodiment, the same components as those in the above embodiment are denoted by the same reference numerals, and the description thereof may be omitted.

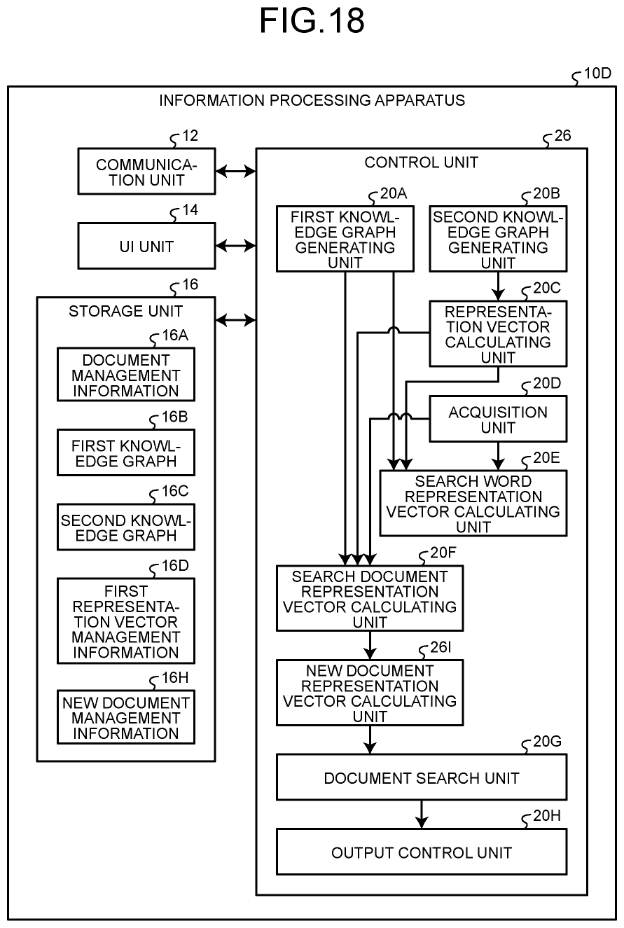

FIG. 18 is a diagram illustrating an example of a functional configuration of an information processing apparatus 10D of the present embodiment.

The information processing apparatus 10D includes a communication unit 12, a UI unit 14, a storage unit 16, and a control unit 26. The communication unit 12, the UI unit 14, the storage unit 16, and the control unit 26 are communicably connected by a bus or the like.

The information processing apparatus 10D is similar to the information processing apparatus 10 of the above embodiment except that the storage unit 16 further stores new document management information 16H and includes a control unit 26 instead of the control unit 20.

The control unit 26 is an arithmetic unit that executes information processing. The control unit 26 includes a first knowledge graph generating unit 20A, a second knowledge graph generating unit 20B, a representation vector calculating unit 20C, an acquisition unit 20D, a search word representation vector calculating unit 20E, a search document representation vector calculating unit 20F, a document search unit 20G, an output control unit 20H, and a new document representation vector calculating unit 26I. The control unit 22 is similar to the control unit 20 of the above embodiment except that the new document representation vector calculating unit 26I is further included.

The new document representation vector calculating unit 26I calculates a search document representation vector of a new document using the new document management information 16H.

The new document management information 16H is a database for managing new documents. The new document is a document that is not registered in the document management information 16A. The new document is, for example, a document newly generated after the document management information 16A is stored in the storage unit 16. For example, when a new document that is not registered in the document management information 16A is specified, the control unit 26 is only required to store the new document and the document ID in the new document management information 16H in association with each other.

When the acquisition unit 20D acquires the search formula, the search word representation vector calculating unit 20E calculates the search word representation vector, and the search document representation vector calculating unit 20F calculates the search document representation vector of the document of the document management information 16A, the new document representation vector calculating unit 26I calculates the search document representation vector of the new document.

Specifically, the new document representation vector calculating unit 26I acquires all the new documents not registered in the document management information 16A from the new document management information 16H.

The new document representation vector calculating unit 26I extracts an important word included in the new document for each of the plurality of acquired new documents. The new document representation vector calculating unit 26I extracts a word included in the new document similarly to the first knowledge graph generating unit 20A and the second knowledge graph generating unit 20B. Then, the new document representation vector calculating unit 26I further specifies a word matching the important word registered in the second knowledge graph 16C among the extracted words. Then, the new document representation vector calculating unit 26I specifies an important word representation vector of an important word which is the specified word from the first representation vector management information 16D.

Then, the new document representation vector calculating unit 26I calculates a statistical representation vector that is a statistical value of the important word representation vector of the specified one or a plurality of important words included in the new document as a search document representation vector of the new document.

Through these processes, the new document representation vector calculating unit 26I calculates the statistical representation vector of the important word representation vector of the important word included in the new document not registered in the document management information 16A as the search document representation vector of the new document.

Then, the document search unit 20G is only required to search a document related to the search word, using the score for each combination of the search word representation vector calculated by the search word representation vector calculating unit 20E and the search document representation vector calculated by each of the search document representation vector calculating unit 20F and the new document representation vector calculating unit 26I, similarly to the above-described embodiment.

Next, an example of a flow of information processing executed by the information processing apparatus 10B according to the present embodiment will be described.

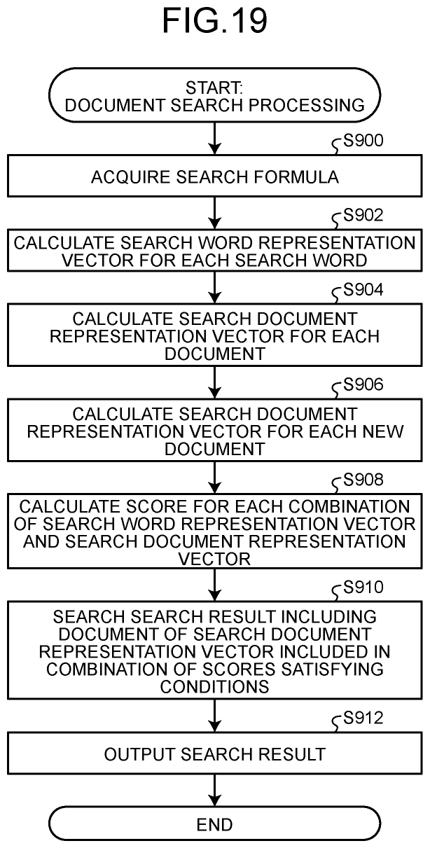

FIG. 19 is a flowchart illustrating an example of a flow of the document search processing.

The acquisition unit 20D acquires a search formula including the search word (step S900). On the basis of the first knowledge graph 16B, the second knowledge graph 16C, and the first representation vector management information 16D, the search word representation vector calculating unit 20E calculates a search word representation vector for each of one or a plurality of search words included in the search formula acquired in step S900 (step S902). On the basis of the first knowledge graph 16B, the second knowledge graph 16C, and the first representation vector management information 16D, the search document representation vector calculating unit 20F calculates a search document representation vector for each of the documents registered in the document management information 16A (step S904). The processing in steps S900 to S904 is similar to that in steps S400 to S404 in the above embodiment illustrated in FIG. 9.

For each of the new documents registered in the new document management information 16H, the new document representation vector calculating unit 26I calculates the statistical representation vector of the important word representation vector of the included important word as the search document representation vector of the new document (step S906).

The document search unit 20G calculates a score representing the degree of relevance for each combination of one or a plurality of search word representation vectors calculated in step S902, each of the plurality of search document representation vectors calculated in step S904, and the search document representation vector of one or a plurality of new documents calculated in step S906 (step S908). Then, the document search unit 20G searches the document represented by the search document representation vector included in the combination as the search result of the search word in accordance with the score calculated in step S908 (step S910).

The output control unit 20H outputs the search result of step S910 (step S912). Then, this routine is ended.

As described above, the information processing apparatus 10D according to the present embodiment calculates the statistical representation vector of the important word representation vector of the important word included in the new document as the search document representation vector of the new document for the new document that is not registered in the document management information 16A.

Therefore, in a case where a new document is generated, the information processing apparatus 10D of the present embodiment can perform the document search processing including the new document as the document to be searched without re-creating the first knowledge graph 16B, the second knowledge graph 16C, and the first representation vector management information 16D.

Therefore, the information processing apparatus 10D of the present embodiment can enable efficient document search with a wide range of search words in addition to the effects of the above embodiment.

### Fifth Embodiment

In the present embodiment, a mode in which feedback information for a search result by a user is used for selection of an important word will be described. In the present embodiment, the same components as those in the above embodiment are denoted by the same reference numerals, and the description thereof may be omitted.

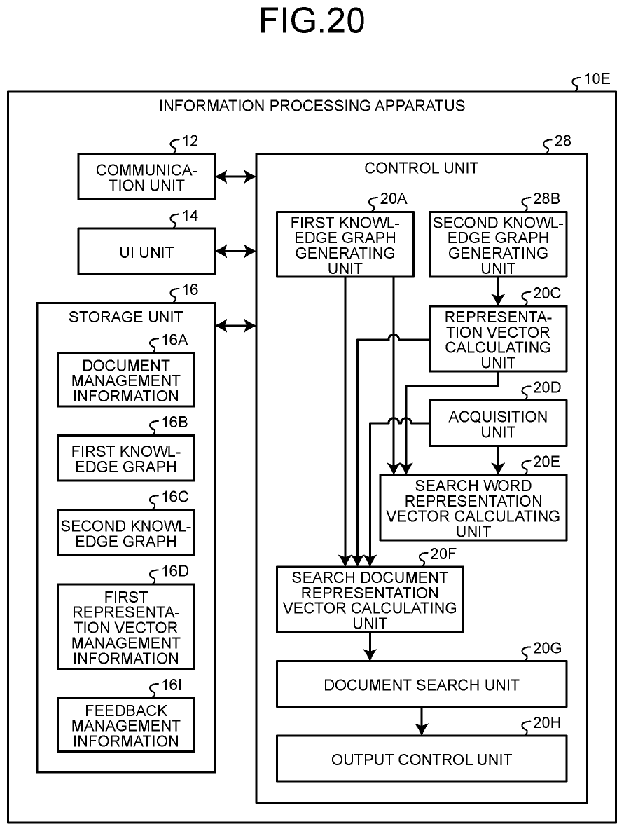

FIG. 20 is a diagram illustrating an example of a functional configuration of an information processing apparatus 10E of the present embodiment.

The information processing apparatus 10E includes a communication unit 12, a UI unit 14, a storage unit 16, and a control unit 28. The communication unit 12, the UI unit 14, the storage unit 16, and the control unit 28 are communicably connected by a bus or the like.

The information processing apparatus 10E is similar to the information processing apparatus 10 of the above embodiment except that the storage unit 16 further stores a feedback management information 16I and includes the control unit 28 instead of the control unit 20.

The feedback management information 16I is a database for managing feedback information for a search result by the user.

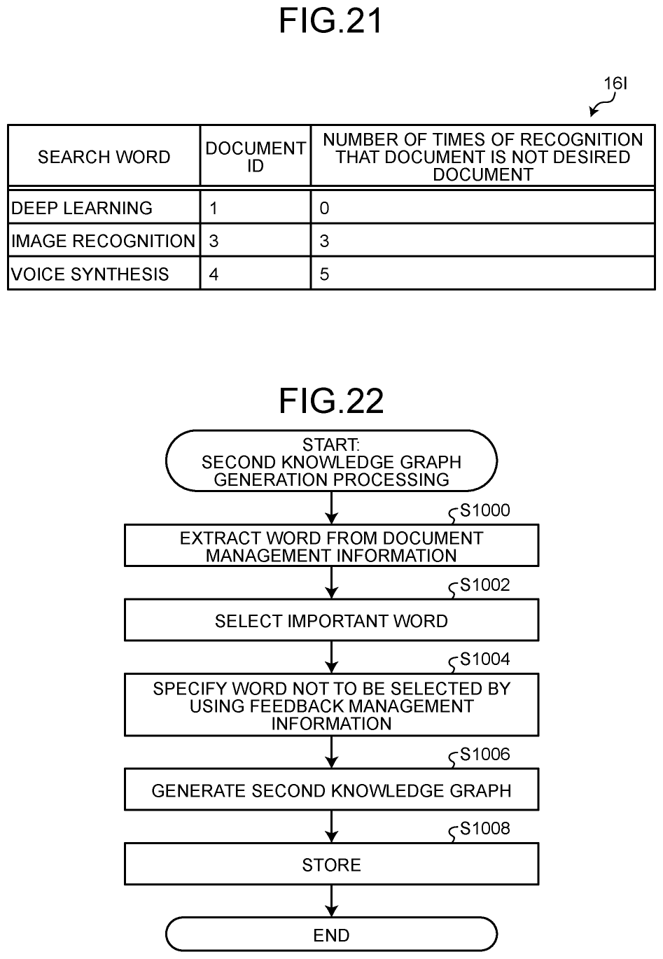

FIG. 21 is a schematic diagram illustrating an example of a data configuration of the feedback management information 16I. The feedback management information 16I is a database in which the search word, the document ID, and the number of times of recognition that the document is not the desired document are associated with each other. A data format of the feedback management information 16I is not limited to the database.

The search word registered in the feedback management information 16I is a search word included in the search formula acquired by the acquisition unit 20D in the past. That is, the search word registered in the feedback management information 16I is a search word input by the user in the past as a keyword for search.

The document ID registered in the feedback management information 16I is the document ID of the document searched as the search result of the search word.

The number of times of recognition that the document is not the desired document registered in the feedback management information 16I indicates the number of times of recognition that the document identified by the corresponding document ID is not the desired document of the user as the document of the search result of the corresponding search word.

For example, the control unit 28 outputs a search result corresponding to the search formula acquired by the acquisition unit 20D to the information processing apparatus or the like of the user to provide the search result, and then receives feedback information regarding the search result from the user. The feedback information includes a search word, a document ID of a document provided as a search result corresponding to the search word, and information indicating whether or not the search result is a document desired by the user. In a case where the information indicating whether or not the search result is the document desired by the user included in the received feedback information indicates that the document is not the desired document, the control unit 28 executes the following processing. In this case, the control unit 28 counts up the number of times of recognition that the document is not the desired document corresponding to the search word and the document ID included in the received feedback information in the feedback management information 16I by “1”.

Through these processes, the number of times of recognition that the document is not the desired document as the feedback result by the user is registered in the feedback management information 16I for each of the search word and the document ID of the document searched as the search result of the search word.

Returning to FIG. 20, the description will be continued.

A second knowledge graph generating unit 28B generates the second knowledge graph 16C similarly to the second knowledge graph generating unit 20B of the first embodiment. The second knowledge graph generating unit 28B selects an important word by a method different from that of the second knowledge graph generating unit 20B.

The second knowledge graph generating unit 28B of the present embodiment selects an important word using the feedback management information 16I.

Specifically, the second knowledge graph generating unit 28B excludes, from the selection target as the important word, a word included in a document that is recognized by the user a predetermined number of times or more as not being a desired document as a search result for the search word among words included in the documents registered in the document management information 16A. The predetermined number of times may be a value of 1 or more, and may be set in advance by an administrator or the like.

In this case, the second knowledge graph generating unit 28B selects the important word from the words included in the document registered in the document management information 16A, for example, similarly to at least one of the second knowledge graph generating unit 20B of the first embodiment and the second knowledge graph generating unit 24B of the third embodiment.

Then, the second knowledge graph generating unit 28B is only required to exclude, among the selected important words, a word included in a document for which the number of times of recognition that the document is not the desired document in the feedback management information 16I is equal to or more than a predetermined number of times (at least one or more) from the selection target when newly selecting the important word.

Then, the second knowledge graph generating unit 28B deletes the important word excluded from the selection target from the second knowledge graph 16C. Among the words included in all the documents registered in the document management information 16A, the second knowledge graph generating unit 28B may delete, from the second knowledge graph 16C, the important word matching the search word for which the number of times of recognition that the document is not the desired document in the feedback management information 16I is equal to or more than a predetermined number of times (at least one or more).

Through these processes, the second knowledge graph generating unit 28B excludes, from the selection target as the important word, a word included in a document that has been recognized by the user a predetermined number of times or more as not being a desired document as a search result for the search word among words included in the documents registered in the document management information 16A.

Therefore, the information processing apparatus 10E of the present embodiment can improve performance related to document search.

FIG. 22 is a flowchart illustrating an example of a flow of generation processing of the second knowledge graph 16C.

The second knowledge graph generating unit 28B extracts all the words included in each of all the documents registered in the document management information 16A (step S1000).

The second knowledge graph generating unit 28B selects an important word similarly to the second knowledge graph generating unit 20B and the second knowledge graph generating unit 24B of the above embodiment (step S1002).

Among the important words selected in step S10002, the second knowledge graph generating unit 28B specifies a word matching the search word for which the number of times of recognition that the document is not the desired document in the feedback management information 16I is equal to or more than a predetermined number of times (at least one or more) as a word not selected as an important word (step S1004).

The second knowledge graph generating unit 28B generates the second knowledge graph 16C by associating the important word other than the important word specified as the word not to be selected in step S1004 among the important words selected in step S1002 with the document ID of the document including the important word (step S1006). Then, the second knowledge graph generating unit 28B stores the second knowledge graph 16C generated in step S1006 in the storage unit 16 (step S1008). Then, this routine is ended.

As described above, the information processing apparatus 10E according to the present embodiment excludes a word included in a document that has been recognized by the user a predetermined number of times or more as not being a desired document as a search result for the search word among words included in documents registered in the document management information 16A, from words to be selected as important words.

Therefore, the information processing apparatus 10E of the present embodiment can suppress an adverse effect on the document search by the important word included in the document recognized by the user as not a desired document.

Therefore, the information processing apparatus 10E of the present embodiment can improve the search accuracy of document search in addition to the effects of the above embodiment.

Next, an example of a hardware configuration of the information processing apparatus 10 to the information processing apparatus 10E according to the above embodiment will be described.

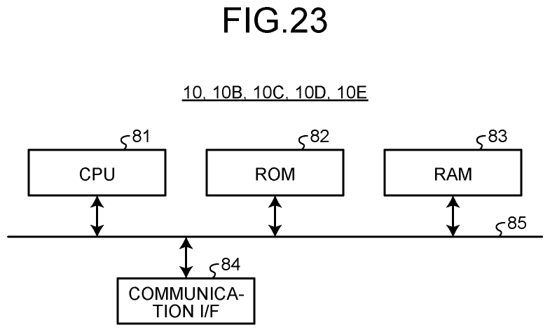

FIG. 23 is a hardware configuration diagram of an example of the information processing apparatus 10 to the information processing apparatus 10E according to the above embodiment.

The information processing apparatus 10 to the information processing apparatus 10E of the above embodiment include a central processing unit (CPU) 81, a read only memory (ROM) 82, a random access memory (RAM) 83, a communication I/F 84, and the like, which are connected to each other via a bus 85, and have a hardware configuration using a normal computer.

The CPU 81 is an arithmetic device that controls the information processing apparatus 10 to the information processing apparatus 10E of the above embodiment. The ROM 82 stores programs and the like for implementing various processes by the CPU 81. Although the CPU is used in the description here, a graphics processing unit (GPU) may be used as an arithmetic device that controls the information processing apparatus 10 to the information processing apparatus 10E. The RAM 83 stores data necessary for various processes by the CPU 81. The communication I/F 84 is an interface for transmitting and receiving data.

In the information processing apparatus 10 to the information processing apparatus 10E of the above embodiment, the CPU 81 reads the program from the ROM 82 onto the RAM 83 and executes the program, whereby the above functions are implemented on the computer.

Note that the program for executing each of the above-described processes executed by the information processing apparatus 10 to the information processing apparatus 10E according to the above-described embodiment may be stored in a hard disk drive (HDD). Furthermore, the program for executing each of the above-described processes executed by the information processing apparatus 10 to the information processing apparatus 10E of the above-described embodiment may be provided by being incorporated in the ROM 82 in advance.

Furthermore, the program for executing the above-described processes executed by the information processing apparatus 10 to the information processing apparatus 10E according to the above-described embodiment may be stored in a computer-readable storage medium such as a CD-ROM, a CD-R, a memory card, a digital versatile disk (DVD), or a flexible disk (FD) as a file in an installable format or an executable format and provided as a computer program product. Furthermore, the program for executing the above-described processes executed by the information processing apparatus 10 to the information processing apparatus 10E according to the above-described embodiment may be stored on a computer connected to a network such as the Internet and provided by being downloaded via the network. Furthermore, the program for executing the above-described processes executed by the information processing apparatus 10 to the information processing apparatus 10E of the above-described embodiment may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Note that the present technology can also have the following configurations.

Example 1. According to an embodiment, an information processing apparatus includes a hardware processor configured to function as a control unit. The control unit calculates a search word representation vector of a search word and a search document representation vector used for searching a plurality of documents registered in document management information on a basis of first knowledge graph, a second knowledge graph, and first representation vector management information in which a first word representation vector of the first word and a document representation vector of the document including the first word are registered. The first knowledge graph represents a relationship between a document registered in the document management information and a word included in the document.

The second knowledge graph represents a relationship between a first word that is the word included in the document and the document including the first word. Additionally, the control unit searches, on a basis of combinations of the search word representation vector and a plurality of the search document representation vectors, the document represented by the search document representation vector included in the combinations.

Example 2. In information processing apparatus according to example 1, the control unit includes a search word representation vector calculating unit, a search document representation vector calculating unit, and a document search unit. The search word representation vector calculating unit calculates the search word representation vector on a basis of the first knowledge graph, the second knowledge graph, and the first representation vector management information. The search document representation vector calculating unit calculates the search document representation vector on a basis of the first knowledge graph, the second knowledge graph, and the first representation vector management information. The document search unit searches the document represented by the search document representation vector included in the combinations on a basis of the combinations.

Example 3. In information processing apparatus according to example 1 or 2, the control unit includes a representation vector calculating unit that calculates the first word representation vector of the first word and the document representation vector of the document including the first word on a basis of the second knowledge graph, and registers the first word representation vector and the document representation vector in the first representation vector management information.

Example 4. In information processing apparatus according to example 3, the representation vector calculating unit calculates the first word representation vector and the document representation vector on a basis of a learning result of a graph structure represented by a relationship between the first word registered in the second knowledge graph and the document.

Example 5. In information processing apparatus according to example 3 or 4, the representation vector calculating unit calculates a first statistical representation vector of a representation vector of each of the documents including the first word for each of first words registered in the second knowledge graph. The representation vector calculating unit calculates a second statistical representation vector of a representation vector of each of the first words included in the document for each of the documents registered in the document management information. The representation vector calculating unit repeats calculation and correction of the first statistical representation vector and the second statistical representation vector until a change in the representation vector after the correction is made such that a value of an objective function for each pair of the first statistical representation vector and the second statistical representation vector becomes a value corresponding to a relationship between the first word represented by the second knowledge graph and the document becomes less than a predetermined value, and calculates the representation vector of the first word after correction and the representation vector of the document after correction when the change becomes less than the predetermined value as the first word representation vector and the document representation vector.

Example 6. In information processing apparatus according to any one of examples 1 to 5, the control unit includes a second knowledge graph generating unit that generates the second knowledge graph on a basis of the first word selected from the document registered in the document management information.

Example 7. In information processing apparatus according to example 6, the second knowledge graph generating unit selects a predetermined number of the words as the first words in descending order of the number of appearances in the document management information among the words included in the document registered in the document management information.

Example 8. In information processing apparatus according to example 6 or 7, the second knowledge graph generating unit registers, among the selected first words, the first word having a predetermined number of appearances or more in the document registered in the document management information, in the second knowledge graph in association with the document including the first word.

Example 9. In information processing apparatus according to any one of examples 6 to 8, the second knowledge graph generating unit selects, as the first word, the word that matches a designated important word designated in advance and registered in important word management information in which the designated important word is registered among the words included in the document registered in the document management information.

Example 10. In information processing apparatus according to any one of examples 6 to 9, the second knowledge graph generating unit selects, as the first word, the word previously acquired as the search word among the words included in the document registered in the document management information.

Example 11. In information processing apparatus according to any one of examples 6 to 10, the second knowledge graph generating unit selects, as the first word, the word biased-appearing in the document of a specific category among the words included in the document registered in the document management information.

Example 12. In information processing apparatus according to any one of examples 6 to 11, the second knowledge graph generating unit excludes the word included in the document recognized by a user a predetermined number of times or more as not being a desired document as a search result for the search word among the words included in the document registered in the document management information from a selection target as the first word.

Example 13. In information processing apparatus according to any one of examples 2 to 12, the search word representation vector calculating unit calculates, as the search word representation vector, a statistical representation vector of the document representation vector of the document registered in the first representation vector management information among a plurality of the documents including the search word specified from the first knowledge graph as the word.

Example 14. In information processing apparatus according to example 13, the search word representation vector calculating unit calculates, as the search word representation vector, a corrected representation vector obtained by correcting a vector value of the statistical representation vector in accordance with a predetermined minimum value and maximum value.

Example 15. In information processing apparatus according to any one of examples 2 to 14, the search document representation vector calculating unit specifies the first word representation vector of the first word associated with the document in the second knowledge graph from the first representation vector management information for each of a plurality of the documents registered in the document management information, and calculates a statistical representation vector of the specified first word representation vector as the search document representation vector.

Example 16. In information processing apparatus according to example 15, the search document representation vector calculating unit calculates, as the search document representation vector, a corrected representation vector obtained by correcting a vector value of the statistical representation vector of the first word representation vector in accordance with a predetermined minimum value and maximum value.

Example 17. In information processing apparatus according to any one of examples 5 to 16, the representation vector calculating unit registers the second statistical representation vector and the document in association with each other in second representation vector management information. The search document representation vector calculating unit calculates the second statistical representation vector corresponding to each of a plurality of the documents registered in the document management information as the search document representation vector.

Example 18. In information processing apparatus according to any one of examples 1 to 17, the control unit includes a new document representation vector calculating unit that calculates a statistical representation vector of the first word representation vector of the first word included in a new document that is not registered in the document management information as the search document representation vector of the new document.

Example 19. In information processing apparatus according to any one of examples 2 to 18, the document search unit searches the document represented by the search document representation vector included in the combinations as a search result of the search word.

Example 20. In information processing apparatus according to any one of examples 2 to 19, the document search unit searches the document represented by the search document representation vector included in the combinations in accordance with a score representing a degree of association for each of the combinations of the search word representation vector and each of a plurality of the search document representation vectors.

Example 21. In information processing apparatus according to example 20, the document search unit searches the document represented by the search document representation vector included in the combinations satisfying at least one of conditions of a predetermined number in a descending order of the score and the score equal to or greater than a predetermined threshold.

Example 22. In information processing apparatus according to example 20 or 21, the document search unit calculates, in a case where a search condition included in a search formula including the search word represents an AND search, a higher score as the degree of association is higher, for each of the combinations of the search word representation vector and a plurality of the search document representation vectors.

Example 23. In information processing apparatus according to any one of examples 20 to 22, the document search unit calculates, in a case where a search condition included in a search formula including the search word represents a NOT search, a higher score as the degree of association is lower using an inverse vector in which directions of vectors of the search word representation vector and the document representation vector are reversed.

Example 24. In information processing apparatus according to any one of examples 21 to 23, the document search unit determines the threshold in accordance with the score of the combination with the search document representation vector of the document including the search word.

Example 25. In information processing apparatus according to any one of examples 21 to 24, the document search unit determines a threshold value in accordance with a distribution of the scores of the combinations.

Example 26. In information processing apparatus according to any one of examples 2 to 25, the hardware processor is configured to further function as an output control unit that output a search result of the document by the document search unit.

Example 27. In information processing apparatus according to example 26, the output control unit outputs the search result including at least one of the document searched as the search result of the search word, a score representing a degree of association of the combination including the search document representation vector of the searched document, and a related word that is the word included in the searched document.

Example 28. In information processing apparatus according to any one of examples 1 to 27, the first word is an important word.

Example 29. According to an embodiment, an information processing method implemented by a computer includes calculating a search word representation vector of a search word and a search document representation vector used for searching a plurality of documents registered in document management information on a basis of a first knowledge graph representing a relationship between a document registered in the document management information and a word included in the document, a second knowledge graph representing a relationship between a first word that is the word included in the document and the document including the first word, and first representation vector management information in which a first word representation vector of the first word and a document representation vector of the document including the first word are registered; and searching on a basis of combinations of the search word representation vector and a plurality of the search document representation vectors. Where, the document is represented by the search document representation vector included in the combinations.

Example 30. According to an embodiment, an information processing computer program product has a non-transitory computer readable medium including programmed instructions. When executed by a computer, the instructions cause the computer to execute: calculating a search word representation vector of a search word and a search document representation vector used for searching a plurality of documents registered in document management information on a basis of a first knowledge graph representing a relationship between a document registered in the document management information and a word included in the document, a second knowledge graph representing a relationship between a first word that is the word included in the document and the document including the first word, and first representation vector management information in which a first word representation vector of the first word and a document representation vector of the document including the first word are registered; and searching on a basis of combinations of the search word representation vector and a plurality of the search document representation vectors. Where, the document is represented by the search document representation vector included in the combinations.

What is claimed is:

1. An information processing apparatus, comprising:
a hardware processor configured to function as:
a control unit that calculates a search word representation vector of a search word and a search document representation vector used for searching a plurality of documents registered in document management information on a basis of a first knowledge graph representing a relationship between a document registered in the document management information and a word included in the document, a second knowledge graph representing a relationship between a first word that is the word included in the document and the document including the first word, and first representation vector management information in which a first word representation vector of the first word and a document representation vector of the document including the first word are registered, and searches, on a basis of combinations of the search word representation vector and a plurality of the search document representation vectors, the document represented by the search document representation vector included in the combinations.

2. The information processing apparatus according to claim 1, wherein
the control unit includes:
a search word representation vector calculating unit that calculates the search word representation vector on a basis of the first knowledge graph, the second knowledge graph, and the first representation vector management information;
a search document representation vector calculating unit that calculates the search document representation vector on a basis of the first knowledge graph, the second knowledge graph, and the first representation vector management information; and
a document search unit that searches the document represented by the search document representation vector included in the combinations on a basis of the combinations.

3. The information processing apparatus according to claim 1, wherein
the control unit includes
a representation vector calculating unit that calculates the first word representation vector of the first word and the document representation vector of the document including the first word on a basis of the second knowledge graph, and registers the first word representation vector and the document representation vector in the first representation vector management information.

4. The information processing apparatus according to claim 3, wherein
the representation vector calculating unit
calculates the first word representation vector and the document representation vector on a basis of a learning result of a graph structure represented by a relationship between the first word registered in the second knowledge graph and the document.

5. The information processing apparatus according to claim 3, wherein
the representation vector calculating unit
calculates a first statistical representation vector of a representation vector of each of the documents including the first word for each of first words registered in the second knowledge graph,
calculates a second statistical representation vector of a representation vector of each of the first words included in the document for each of the documents registered in the document management information, and
repeats calculation and correction of the first statistical representation vector and the second statistical representation vector until a change in the representation vector after the correction is made such that a value of an objective function for each pair of the first statistical representation vector and the second statistical representation vector becomes a value corresponding to a relationship between the first word represented by the second knowledge graph and the document becomes less than a predetermined value, and calculates the representation vector of the first word after correction and the representation vector of the document after correction when the change becomes less than the predetermined value as the first word representation vector and the document representation vector.

6. The information processing apparatus according to claim 1, wherein
the control unit includes
a second knowledge graph generating unit that generates the second knowledge graph on a basis of the first word selected from the document registered in the document management information.

7. The information processing apparatus according to claim 6, wherein
the second knowledge graph generating unit
selects a predetermined number of the words as the first words in descending order of the number of appearances in the document management information among the words included in the document registered in the document management information.

8. The information processing apparatus according to claim 6, wherein
the second knowledge graph generating unit registers,
among the selected first words,
the first word having a predetermined number of appearances or more in the document registered in the document management information, in the second knowledge graph in association with the document including the first word.

9. The information processing apparatus according to claim 6, wherein
the second knowledge graph generating unit
selects, as the first word, the word that matches a designated important word designated in advance and registered in important word management information in which the designated important word is registered among the words included in the document registered in the document management information.

10. The information processing apparatus according to claim 6, wherein
the second knowledge graph generating unit
selects, as the first word, the word previously acquired as the search word among the words included in the document registered in the document management information.

11. The information processing apparatus according to claim 6, wherein
the second knowledge graph generating unit
selects, as the first word, the word biased-appearing in the document of a specific category among the words included in the document registered in the document management information.

12. The information processing apparatus according to claim 6, wherein
the second knowledge graph generating unit
excludes the word included in the document recognized by a user a predetermined number of times or more as not being a desired document as a search result for the search word among the words included in the document registered in the document management information from a selection target as the first word.

13. The information processing apparatus according to claim 2, wherein
the search word representation vector calculating unit
calculates, as the search word representation vector, a statistical representation vector of the document representation vector of the document registered in the first representation vector management information among a plurality of the documents including the search word specified from the first knowledge graph as the word.

14. The information processing apparatus according to claim 13, wherein
the search word representation vector calculating unit
calculates, as the search word representation vector, a corrected representation vector obtained by correcting a vector value of the statistical representation vector in accordance with a predetermined minimum value and maximum value.

15. The information processing apparatus according to claim 2, wherein
the search document representation vector calculating unit
specifies the first word representation vector of the first word associated with the document in the second knowledge graph from the first representation vector management information for each of a plurality of the documents registered in the document management information, and calculates a statistical representation vector of the specified first word representation vector as the search document representation vector.

16. The information processing apparatus according to claim 15, wherein
the search document representation vector calculating unit
calculates, as the search document representation vector, a corrected representation vector obtained by correcting a vector value of the statistical representation vector of the first word representation vector in accordance with a predetermined minimum value and maximum value.

17. The information processing apparatus according to claim 5, wherein
the representation vector calculating unit
registers the second statistical representation vector and the document in association with each other in second representation vector management information, and
the search document representation vector calculating unit
calculates the second statistical representation vector corresponding to each of a plurality of the documents registered in the document management information as the search document representation vector.

18. The information processing apparatus according to claim 1, wherein
the control unit includes
a new document representation vector calculating unit that calculates a statistical representation vector of the first word representation vector of the first word included in a new document that is not registered in the document management information as the search document representation vector of the new document.

19. The information processing apparatus according to claim 2, wherein
the document search unit
searches the document represented by the search document representation vector included in the combinations as a search result of the search word.

20. The information processing apparatus according to claim 2, wherein
the document search unit
searches the document represented by the search document representation vector included in the combinations in accordance with a score representing a degree of association for each of the combinations of the search word representation vector and each of a plurality of the search document representation vectors.

21. The information processing apparatus according to claim 20, wherein
the document search unit
searches the document represented by the search document representation vector included in the combinations satisfying at least one of conditions of a predetermined number in a descending order of the score and the score equal to or greater than a predetermined threshold.

22. The information processing apparatus according to claim 20, wherein
the document search unit
calculates, in a case where a search condition included in a search formula including the search word represents an AND search, a higher score as the degree of association is higher, for each of the combinations of the search word representation vector and a plurality of the search document representation vectors.

23. The information processing apparatus according to claim 20, wherein
the document search unit
calculates, in a case where a search condition included in a search formula including the search word represents a NOT search, a higher score as the degree of association is lower using an inverse vector in which directions of vectors of the search word representation vector and the document representation vector are reversed.

24. The information processing apparatus according to claim 21, wherein
the document search unit
determines the threshold in accordance with the score of the combination with the search document representation vector of the document including the search word.

25. The information processing apparatus according to claim 21, wherein
the document search unit
determines a threshold value in accordance with a distribution of the scores of the combinations.

26. The information processing apparatus according to claim 2, wherein the hardware processor is configured to further function as:
an output control unit that output a search result of the document by the document search unit.

27. The information processing apparatus according to claim 26, wherein
the output control unit
outputs the search result including at least one of the document searched as the search result of the search word, a score representing a degree of association of the combination including the search document representation vector of the searched document, and a related word that is the word included in the searched document.

28. The information processing apparatus according to claim 1, wherein
the first word is an important word.

29. An information processing method, comprising:
calculating, by a computer, a search word representation vector of a search word and a search document representation vector used for searching a plurality of documents registered in document management information on a basis of a first knowledge graph representing a relationship between a document registered in the document management information and a word included in the document, a second knowledge graph representing a relationship between a first word that is the word included in the document and the document including the first word, and first representation vector management information in which a first word representation vector of the first word and a document representation vector of the document including the first word are registered; and
searching, by the computer, on a basis of combinations of the search word representation vector and a plurality of the search document representation vectors, the document represented by the search document representation vector included in the combinations.

30. An information processing computer program product having a non-transitory computer readable medium including programmed instructions, wherein the instructions, when executed by a computer, cause the computer to execute:
calculating a search word representation vector of a search word and a search document representation vector used for searching a plurality of documents registered in document management information on a basis of a first knowledge graph representing a relationship between a document registered in the document management information and a word included in the document, a second knowledge graph representing a relationship between a first word that is the word included in the document and the document including the first word, and first representation vector management information in which a first word representation vector of the first word and a document representation vector of the document including the first word are registered; and
searching, on a basis of combinations of the search word representation vector and a plurality of the search document representation vectors, the document represented by the search document representation vector included in the combinations.
